(19) United States
(12) Patent Application Publication
(10) Pub. No.: US 2017/0025232 A1
(43) Pub. Date: Jan. 26, 2017

(54) CONTACT DEVICE

(71) Applicant: Panasonic intellectual Property Management Co., Ltd., Osaka (JP)

(72) Inventors: HISASHI HIRAKI, Osaka (JP); MASAKAZU KOBAYASHI, Osaka (JP)

(21) Appl. No.: 15/300,735

(22) PCT Filed: May 19, 2015
(86) PCT No.: PCT/JP2015/002509

§ 371 Date: Sep. 29, 2016

(30) Foreign Application Priority Data
May 20, 2014 (JP) 2014-104593
May 20, 2014 (JP) 2014-104595
May 20, 2014 (JP) 2014-104596

(51) Int. Cl. H01H 9/44; H01H 50/38; H01H 9/34

(52) U.S. Cl. CPC H01H 9/443; H01H 9/342; H01H 50/38

(57) ABSTRACT

An aspect of the present invention includes a first contact unit including a fixed contact and a movable contact configured to move between a closed position at which the movable contact is in contact with the fixed contact and an open position at which the movable contact is separate from the fixed contact, a magnet configured to generate a magnetic field, and an arc-extinguishing body. Provided that a direction of action is a direction intersecting with a direction of the magnetic field applied to the first contact unit and with a direction in which the movable contact moves, the arc-extinguishing body forms an arc-extinguishing space in the direction of action.

### TECHNICAL FIELD

The present invention generally relates to a contact device, and more particularly to a contact device including a fixed contact and a movable contact.

### BACKGROUND ART

A conventional contact device includes a fixed contact and a movable contact configured to move between a closed position at which the movable contact is in contact with the fixed contact and an open position at which the movable contact is separate from the fixed contact. Such a contact device includes an arc-extinguishing chamber space so as to extinguish an arc generated at contact opening (refer to PTL 1, for example). The arc is extinguished by being extended by a magnetic field in the arc-extinguishing chamber space.

### CITATION LIST

### Patent Literature

PTL 1: Unexamined Japanese Patent Publication No. H11-312449
PTL 2: Unexamined Japanese Patent Publication No. 2010-267470

### SUMMARY OF THE INVENTION

When air in the arc-extinguishing chamber space is expanded by heat of the arc, air pressure in the arc-extinguishing chamber increases. Unfortunately, this increase in air pressure potentially encumbers the extension of the arc, leading to an increase in time taken for extinguishing the arc.

In addition, the extension of the arc only by the magnetic field potentially leads to a longer time taken for extinguishing the arc.

The present invention is made to solve the above-described problems, and it is an object of the present invention to provide a contact device capable of extinguishing an arc fast.

A contact device according to the present invention includes a first contact unit including a fixed contact and a movable contact configured to move between a closed position at which the movable contact is in contact with the fixed contact and an open position at which the movable contact is separate from the fixed contact, a magnet configured to generate a magnetic field, and an arc-extinguishing body. Provided that a direction of action is a direction intersecting with a direction of the magnetic field applied to the first contact unit and with a direction in which the movable contact moves, the arc-extinguishing body forms an arc-extinguishing space in the direction of action.

As described above, according to the present invention, an arc is extended to bypass the arc-extinguishing body, thereby extinguishing the arc fast.

### BRIEF DESCRIPTION OF DRAWINGS

FIG. 1 is a sectional view of a contact device in a first exemplary embodiment.

FIG. 2 is a perspective view of the contact device in the first exemplary embodiment.

FIG. 3 is a front view of the contact device in the first exemplary embodiment.

FIG. 4 is a sectional view illustrating a modification of the contact device in the first exemplary embodiment.

FIG. 5 is a sectional view illustrating a modification of the contact device in the first exemplary embodiment.

FIG. 6 is a perspective view illustrating a modification of the contact device in the first exemplary embodiment.

FIG. 7 is a perspective view illustrating the modification of the contact device in the first exemplary embodiment.

FIG. 8 is a front view illustrating the modification of the contact device in the first exemplary embodiment.

FIG. 9 is a sectional view illustrating the modification of the contact device in the first exemplary embodiment.

FIG. 10 is a perspective view illustrating a modification of the contact device in the first exemplary embodiment.

FIG. 11 is a perspective view illustrating the modification of the contact device in the first exemplary embodiment.

FIG. 12 is a perspective view of a contact device in a second exemplary embodiment.

FIG. 13 is a front view of the contact device in the second exemplary embodiment.

FIG. 14 is a sectional view of the contact device in the second exemplary embodiment.

FIG. 15 is a sectional view illustrating a modification of the contact device in the second exemplary embodiment.

FIG. 16 is a sectional view illustrating a modification of the contact device in the second exemplary embodiment.

FIG. 17 is a perspective view illustrating a modification of the contact device in the second exemplary embodiment.

FIG. 18 is a front view illustrating the modification of the contact device in the second exemplary embodiment.

FIG. 19 is a sectional view of a contact device in a third exemplary embodiment.

FIG. 20 is a perspective view of the contact device in the third exemplary embodiment.

FIG. 21 is a front view of the contact device in the third exemplary embodiment.

FIG. 22 is a sectional view illustrating a modification of the contact device in the third exemplary embodiment.

FIG. 23 is a sectional view illustrating a modification of the contact device in the third exemplary embodiment.

FIG. 24 is a sectional view illustrating a modification of the contact device in the third exemplary embodiment.

FIG. 25 is a perspective view illustrating a modification of the contact device in the third exemplary embodiment.

FIG. 26 is a sectional view illustrating the modification of the contact device in the third exemplary embodiment.

FIG. 27 is a perspective view of a contact device in a fourth exemplary embodiment.

FIG. 28 is a front view of the contact device in the fourth exemplary embodiment.

FIG. 29 is a sectional view of the contact device in the fourth exemplary embodiment.

FIG. 30 is a sectional view illustrating a modification of the contact device in the fourth exemplary embodiment.

FIG. 31 is a perspective view illustrating a modification of the contact device in the fourth exemplary embodiment.

FIG. 32 is a sectional view illustrating a modification of the contact device in the fourth exemplary embodiment.

FIG. 33 is a perspective view illustrating a modification of the contact device in the fourth exemplary embodiment.

FIG. 34 is a perspective view illustrating the modification of the contact device in the fourth exemplary embodiment.

FIG. 35 is a perspective view illustrating a modification of the contact device in the fourth exemplary embodiment.

FIG. 36 is a front view illustrating the modification of the contact device in the fourth exemplary embodiment.

FIG. 37 is a sectional view illustrating the modification of the contact device in the fourth exemplary embodiment.

FIG. 38 is a sectional view illustrating a modification of the contact device in the fourth exemplary embodiment.

FIG. 39 is a perspective view illustrating a modification of the contact device in the fourth exemplary embodiment.

FIG. 40 is a front view illustrating the modification of the contact device in the fourth exemplary embodiment.

FIG. 41 is a sectional view illustrating the modification of the contact device in the fourth exemplary embodiment.

FIG. 42 is a sectional view of a contact device in a fifth exemplary embodiment.

FIG. 43 is a perspective view of the contact device in the fifth exemplary embodiment.

FIG. 44 is a plan view of the contact device in the fifth exemplary embodiment.

FIG. 45 is a main-part enlarged view of the contact device in the fifth exemplary embodiment.

FIG. 46 is a main-part enlarged view of the contact device in the fifth exemplary embodiment.

FIG. 47 is a main-part enlarged view of the contact device in the fifth exemplary embodiment.

FIG. 48 is a perspective view illustrating a modification of the contact device in the fifth exemplary embodiment.

FIG. 49 is a side view illustrating the modification of the contact device in the fifth exemplary embodiment.

FIG. 50 is a perspective view illustrating a modification of the contact device in the fifth exemplary embodiment.

FIG. 51 is a sectional view of a contact device in a sixth exemplary embodiment.

FIG. 52 is a perspective view of the contact device in the sixth exemplary embodiment.

FIG. 53 is a plan view of the contact device in the sixth exemplary embodiment.

FIG. 54 is a perspective view illustrating a modification of the contact device in the sixth exemplary embodiment.

FIG. 55 is a sectional view illustrating a modification of the contact device in the sixth exemplary embodiment.

FIG. 56 is a perspective view illustrating a modification of the contact device in the sixth exemplary embodiment.

FIG. 57 is a sectional view illustrating a modification of the contact device in the sixth exemplary embodiment.

FIG. 58 is a sectional view illustrating a modification of the contact device in the sixth exemplary embodiment.

FIG. 59 is a sectional view illustrating a modification of the contact device in the sixth exemplary embodiment.

FIG. 60 is a sectional view illustrating a modification of the contact device in the sixth exemplary embodiment.

FIG. 61 is a sectional view illustrating a modification of the contact device in the sixth exemplary embodiment.

### DESCRIPTION OF EMBODIMENTS

Exemplary embodiments of the present invention will be described below with reference to the accompanying drawings.

### First Exemplary Embodiment

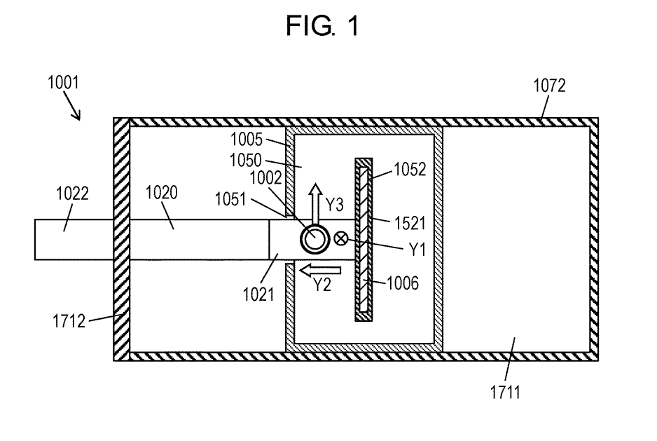

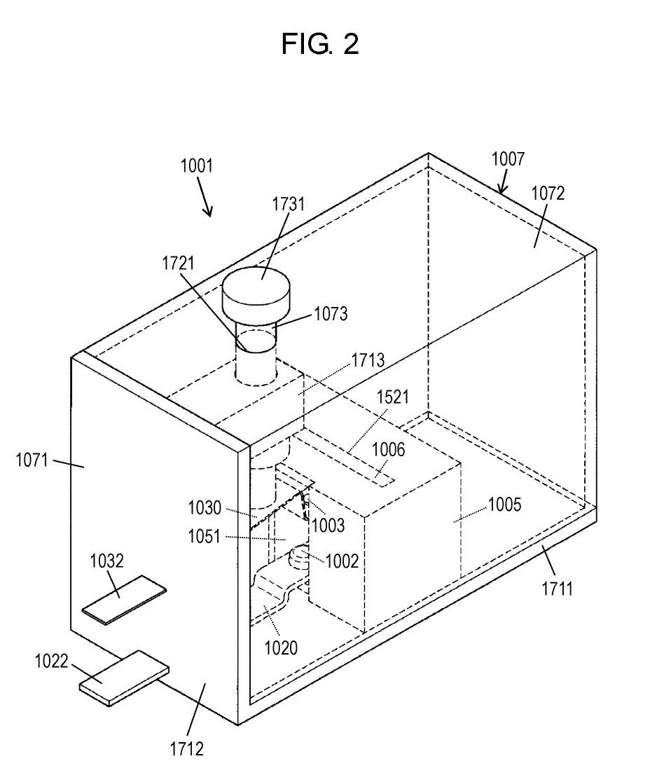

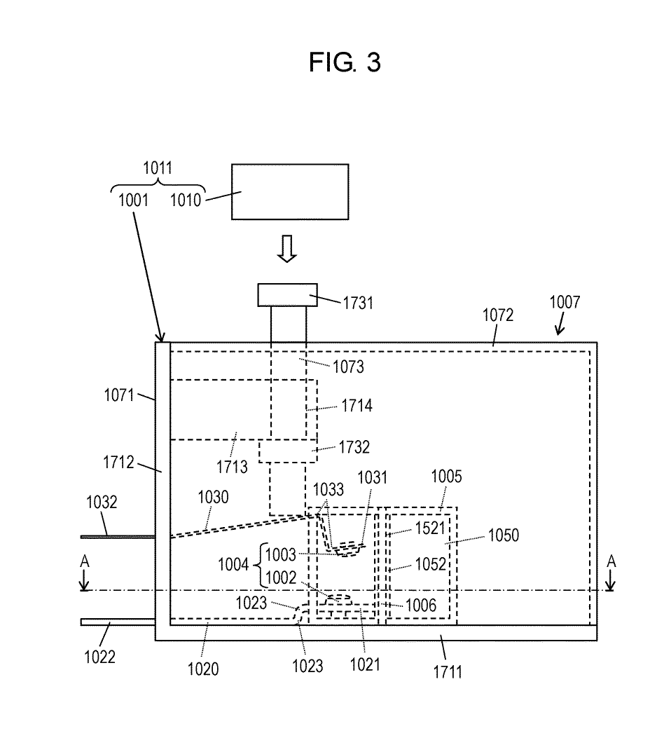

FIG. 2 illustrates an external perspective view of contact device 1001 according to the present exemplary embodiment, and FIG. 3 illustrates a front view of contact device 1001. FIG. 1 illustrates a sectional view taken along line A-A in FIG. 3. As illustrated in FIGS. 1 to 3, contact device 1001 according to the present exemplary embodiment includes contact unit 1004 including fixed contact 1002 and movable contact 1003 configured to move between a closed position at which movable contact 1003 is in contact with fixed contact 1002 and an open position at which movable contact 1003 is separate from fixed contact 1002, magnet 1006 configured to generate a magnetic field, and arc-extinguishing frame 1005 as an exemplary arc-extinguishing body.

The following describes a configuration of contact device 1001 according to the present exemplary embodiment in detail with reference to FIGS. 1 to 3. Up-down and left-right directions in FIG. 3 are defined as up-down and left-right directions in the following description. The front-rear direction is defined to be a direction orthogonal to the up-down and left-right directions, and specifically, the front direction is defined to be a direction away from the drawing plane of FIG. 3 (down direction in FIG. 1), and the rear direction is defined to be a direction toward the drawing plane (up direction in FIG. 1).

The following describes an example in which electromagnetic relay 1011 includes contact device 1001 according to the present exemplary embodiment and electromagnetic device 1010 configured to move movable contact 1003 as illustrated in FIG. 3. Usage of contact device 1001 is not limited to electromagnetic relay 1011, and contact device 1001 may be used in, for example, a switch or a breaker (circuit breaker).

In contact device 1001 according to the present exemplary embodiment, contact unit 1004 (fixed contact 1002, movable contact 1003), arc-extinguishing frame 1005, and magnet 1006 are housed in rectangular parallelepiped case 1007. Case 1007 includes body 1071 and cover 1072 attached to body 1071. Body 1071 is formed in an L shape with bottom plate 1711 and side plate 1712, serving as a bottom part and a left sidewall of case 1007. Cover 1072 is formed in a rectangular parallelepiped shape having a hollow structure with openings on a lower surface and a left surface, and is attached to body 1071 such that body 1071 covers the openings on the lower surface and the left surface.

Fixed contact 1002 is provided to rectangular fixed contact plate 1020 including contact holding part 1021, terminal part 1022, and curved parts 1023. Fixed contact plate 1020 is a metal plate whose longitudinal direction is in the left-right direction and thickness direction is in the up-down direction, and is provided along bottom plate 1711 of body 1071. Fixed contact plate 1020 is formed including two curved parts 1023 such that contact holding part 1021 on a right end side is separate from bottom plate 1711. Fixed contact 1002 is swaged on contact holding part 1021 so that fixed contact 1002 is fixed to an upper surface of contact holding part 1021. Fixed contact plate 1020 is provided penetrating through side plate 1712, and terminal part 1022 protruding from side plate 1712 to a left side is electrically connected with, for example, a power source (not illustrated). In the present exemplary embodiment, fixed contact plate 1020 and fixed contact 1002 are separately provided, but fixed contact plate 1020 and fixed contact 1002 may be integrally provided by, for example, forming fixed contact 1002 through embossing of fixed contact plate 1020.

Movable contact 1003 is provided to rectangular movable contact plate 1030 including contact holding part 1031, terminal part 1032, and curved parts 1033. Movable contact plate 1030 is a metal plate whose longitudinal direction is in the left-right direction and thickness direction is in the up-down direction, and is fixed to side plate 1712 such that a lower surface of movable contact plate 1030 faces an upper surface of fixed contact plate 1020. Movable contact plate 1030 is formed including two curved parts 1033 such that contact holding part 1031 on a right end side is close to bottom plate 1711. Movable contact 1003 is swaged on contact holding part 1031 so that movable contact 1003 is fixed on a lower surface of contact holding part 1031 at a position opposite to fixed contact 1002 in the up-down direction. Movable contact plate 1030 is provided penetrating side plate 1712, and terminal part 1032 protruding from side plate 1712 to a left side is electrically connected with, for example, a load (not illustrated). Movable contact plate 1030 is also used as a plate spring having elasticity in the up-down direction, and the elasticity of movable contact plate 1030 is used for contact closing at which movable contact 1003 and fixed contact 1002 are in contact with each other, and for contact opening at which movable contact 1003 and fixed contact 1002 are separate from each other. In the present exemplary embodiment, movable contact plate 1030 and movable contact 1003 are separately provided, but may be integrally provided by, for example, forming movable contact 1003 through embossing of movable contact plate 1030.

Movable contact plate 1030 is bent by round movable shaft 1073 in the down direction, so that contact holding part 1031 and movable contact 1003 move in the down direction. Movable shaft 1073 is movably held in the up-down direction by holding part 1713 provided protruding from side plate 1712 of case 1007 to a right side, and a lower end of movable shaft 1073 is in contact with an upper surface of movable contact plate 1030.

Holding part 1713 is formed in a rectangular parallelepiped shape and provided at a position above movable contact plate 1030 on side plate 1712. Holding part 1713 is provided with hole 1714 penetrating in the up-down direction, through which movable shaft 1073 is movably held in the up-down direction. Hole 1721 penetrating in the up-down direction is also formed in an upper surface of cover 1072, and movable shaft 1073 is provided such that movable shaft 1073 penetrates hole 1721 of cover 1072. In other words, movable shaft 1073 is held while protruding from case 1007.

First flange part 1731 is formed at an upper end of movable shaft 1073, and a lowest position of movable shaft 1073 is a position at which a lower surface of first flange part 1731 is in contact with the upper surface of cover 1072. In addition, second flange part 1732 of movable shaft 1073 is formed at a position below holding part 1713, and a highest position of movable shaft 1073 is a position at which an upper surface of second flange part 1732 is in contact with a lower surface of holding part 1713.

Movable shaft 1073 is moved in the down direction by electromagnetic device 1010 (refer to FIG. 3). Electromagnetic device 1010 has a conventionally known configuration in which, for example, an excitation coil and a movable iron core not illustrated are included, and the movable iron core configured to be moved in the down direction through magnetic flux generated by the excitation coil when energized is coupled with movable shaft 1073. Thus, when the excitation coil is energized to move the movable iron core in the down direction, movable shaft 1073 is provided with force in the down direction, and is moved in the down direction. The configuration of electromagnetic device 1010 is not limited to the above-described configuration.

When the excitation coil is energized to move movable shaft 1073 in the down direction, movable contact plate 1030 is bent in the down direction so that contact holding part 1031 and movable contact 1003 move in the down direction. Accordingly, movable contact 1003 is brought into contact with fixed contact 1002, so that movable contact plate 1030 and fixed contact plate 1020 have conduction therebetween.

Since movable contact plate 1030 has elasticity in the up-down direction, an upward force due to a restoring force for returning movable contact plate 1030 from the bent state to the original state acts to separate movable contact 1003 from fixed contact 1002. When the energization of the excitation coil is stopped and the downward force on movable shaft 1073 is canceled, the restoring force of movable contact plate 1030 moves contact holding part 1021 in the up direction, so that movable contact 1003 separates from fixed contact 1002.

In this manner, movable contact 1003 moves in the up-down direction between the closed position at which movable contact 1003 is in contact with fixed contact 1002 and the open position at which movable contact 1003 is separate from fixed contact 1002.

At the contact opening at which movable contact 1003 is separate from fixed contact 1002, an arc is potentially generated between movable contact 1003 and fixed contact 1002. The arc has a high temperature and generates gas including metal in some cases. For this reason, contact device 1001 according to the present exemplary embodiment includes arc-extinguishing frame 1005 configured to prevent scattering of, for example, metal included in the gas generated by the arc, and magnet 1006 configured to extinguish an arc by extending the arc using a magnetic field.

Arc-extinguishing frame 1005 is an insulator, such as resin or ceramic, having an electric insulation property, formed in a rectangular parallelepiped shape, and provided surrounding contact unit 1004. In order to house contact unit 1004 in arc-extinguishing frame 1005, rectangular hole 1051 is formed in a range from an upper end to a lower end of a central part in the front-rear direction on a left sidewall of arc-extinguishing frame 1005. Fixed contact plate 1020 and movable contact plate 1030 are disposed through hole 1051 so as to house contact unit 1004 (fixed contact 1002, movable contact 1003) in arc-extinguishing frame 1005.

Arc-extinguishing frame 1005 includes internal wall 1052, and forms ring-shaped circulating flow path 1050 around internal wall 1052. Internal wall 1052 is formed in a plate shape whose thickness direction is in the left-right direction. Internal wall 1052 is formed to couple lower and upper surfaces of arc-extinguishing frame 1005 in the central part of arc-extinguishing frame 1005 in the left-right direction. A gap is formed between a sidewall of arc-extinguishing frame 1005 and internal wall 1052, serving as ring-shaped circulating flow path 1050 around internal wall 1052, and thereby circulating an air current in a circumferential direction. Circulating flow path 1050 is formed in a rectangle whose longitudinal direction is in the front-rear direction, and contact unit 1004 is disposed in a central part of circulating flow path 1050 in the front-rear direction.

Rectangular hole 1521 penetrating in the up-down direction is formed in internal wall 1052, and magnet 1006 is inserted into hole 1521.

Magnet 1006 is formed in a plate shape whose thickness direction is in the left-right direction, and applies a magnetic field toward the left direction on contact unit 1004. This magnetic field exerts a Lorentz force on an arc, thereby extending the arc to extinguish the arc. For example, when current flows from movable contact 1003 toward fixed contact 1002, the arc is extended toward the rear direction (the up direction in FIG. 1). In contrast, when current flows from fixed contact 1002 toward movable contact 1003, the arc is extended toward the front direction (the down direction in FIG. 1). In other words, the arc is extended along circulating flow path 1050 irrespective of a direction in which current flows.

In the case in which current flows from movable contact 1003 toward fixed contact 1002, in FIG. 1, arrow Y1 represents a direction in which the current flows, arrow Y2 represents a direction of the magnetic field, and arrow Y3 represents a direction in which the arc is extended. In the case in which current flows from fixed contact 1002 toward movable contact 1003, the direction in which the arc is extended is opposite to the direction of arrow Y3.

As described above, an arc has a high temperature, air in arc-extinguishing frame 1005 is heated to expand due to heat of the arc. For example, when the arc is extended toward the rear direction, air on a rear side of contact unit 1004 in arc-extinguishing frame 1005 is more heated to expand in particular. Since arc-extinguishing frame 1005 according to the present exemplary embodiment includes circulating flow path 1050, when the air in arc-extinguishing frame 1005 expands, the air can be circulated in the circumferential direction of circulating flow path 1050. For example, when arc is extended toward the rear direction (the up direction in FIG. 1), the air flows clockwise in FIG. 1 through circulating flow path 1050. In contrast, when the arc is extended toward the front direction (the down direction in FIG. 1), the air flows counterclockwise in FIG. 1 through circulating flow path 1050.

In this manner, contact device 1001 according to the present exemplary embodiment includes contact unit 1004 including fixed contact 1002 and movable contact 1003, magnet 1006 configured to generate a magnetic field, and arc-extinguishing frame 1005 (arc-extinguishing body). Movable contact 1003 moves between the closed position at which movable contact 1003 is in contact with fixed contact 1002 and the open position at which movable contact 1003 is separate from fixed contact 1002. The direction of action (the front-rear direction) is a direction intersecting with a direction of a magnetic field applied to contact unit 1004 (the left direction) and with a direction in which movable contact 1003 moves (the up-down direction). Arc-extinguishing frame 1005 (arc-extinguishing body) forms an arc-extinguishing space in the direction of action.

Contact device 1001 according to the present exemplary embodiment, which has the above-described configuration, can easily extend an arc to extinguish the arc faster.

Contact device 1001 according to the present exemplary embodiment further has the following configuration. The arc-extinguishing body includes arc-extinguishing frame 1005, arc-extinguishing frame 1005 is a flow path including a space in which contact unit 1004 is disposed, and at least part of arc-extinguishing frame 1005 forms ring-shaped circulating flow path 1050 in the direction of action (the front-rear direction).

In contact device 1001 according to the present exemplary embodiment, which has the above-described configuration, when the air in arc-extinguishing frame 1005 is heated by heat of an arc, the air flows in the circumferential direction of circulating flow path 1050. This suppresses an increase in air pressure in a direction in which the arc is extended with respect to contact unit 1004. Accordingly, the extension of the arc can be prevented from being encumbered by the increase in air pressure.

Since circulating flow path 1050 is formed in a rectangle whose longitudinal direction is in the front-rear direction, the arc is extended in the front direction or the rear direction in circulating flow path 1050. In other words, air flows in a direction in which the arc is extended. Thus, arc-extinguishing frame 1005 facilitates the extension of the arc, thereby extinguishing the arc faster. The fast extinguishment of the arc enables a fast electric break between fixed contact 1002 and movable contact 1003 at contact opening, thereby achieving improved breaking performance of contact device 1001.

Contact unit 1004 is disposed in the central part in the front-rear direction of circulating flow path 1050 whose longitudinal direction is in the front-rear direction. This allows an arc to be extended in the longitudinal direction of circulating flow path 1050 irrespective of a direction of current flowing through contact unit 1004, thereby facilitating the extension of the arc to extinguish the arc faster.

Arc-extinguishing frame 1005 is provided around contact unit 1004, and gas generated by an arc flows in the circumferential direction of circulating flow path 1050, thereby preventing scattering of metal included in the gas outside arc-extinguishing frame 1005.

Since magnet 1006 is inserted in hole 1521 formed in internal wall 1052 of arc-extinguishing frame 1005, an arc can be prevented from contacting magnet 1006. Since magnet 1006 is provided at a position surrounded by circulating flow path 1050, magnet 1006 can be disposed closer to contact unit 1004 as compared to a case in which magnet 1006 is provided outside of arc-extinguishing frame 1005, thereby allowing a stronger magnetic field to be applied to contact unit 1004. This enables further extension of an arc, thereby extinguishment of the arc faster. Since magnet 1006 is inserted in hole 1521 in internal wall 1052, a space in case 1007 can be effectively used.

Arc-extinguishing frame 1005 does not necessarily need to be integrally formed, but may configured as a combination of a plurality of divided components. This configuration is useful when it is convenient to have a plurality of components at assembly of contact device 1001 and manufacturing of arc-extinguishing frame 1005. Arc-extinguishing frame 1005 may be provided with a hole in addition to hole 1051. The hole provided in arc-extinguishing frame 1005 leads to reduction in a material of arc-extinguishing frame 1005, thereby achieving reduction in cost and weight.

The following describes modifications of contact device 1001 according to the present exemplary embodiment. Any components according to the modifications of contact device 1001 are denoted by reference numerals followed by A, B, C . . . to distinguish the components.

In the present exemplary embodiment, internal wall 1052 is provided at the central part of arc-extinguishing frame 1005 in the left-right direction. Thus, circulating flow path 1050 is formed such that a sectional area of a space in which contact unit 1004 is disposed (space on a left side of internal wall 1052) and a sectional area of a space in which contact unit 1004 is not disposed (space on a right side of internal wall 1052) is identical to each other, but the present invention is not limited thereto.

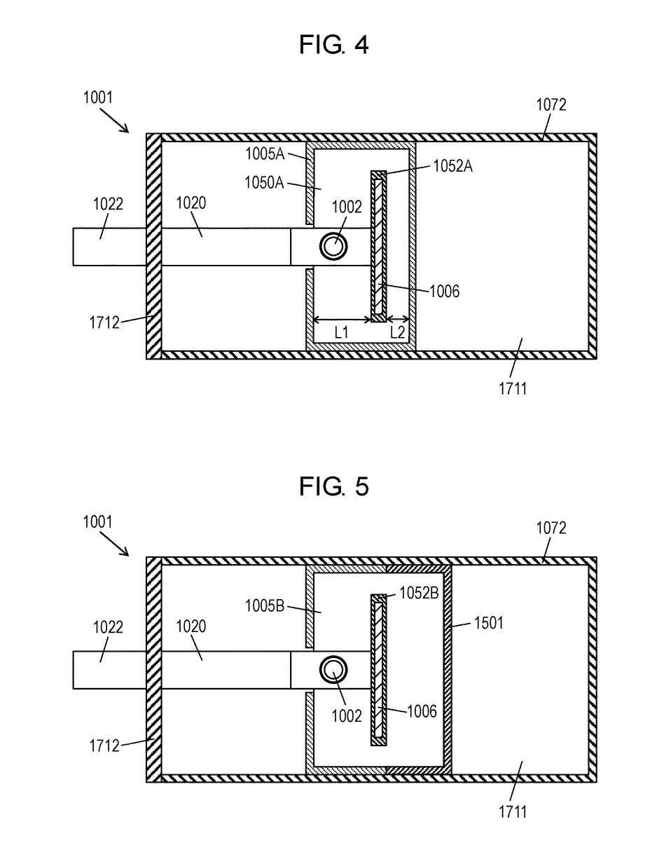

For example, as illustrated in FIG. 4, arc-extinguishing frame 1005A forms circulating flow path 1050A including a space (space on the right side of internal wall 1052A) having a sectional area smaller than the sectional area of the space (space on the left side of internal wall 1052A) in which contact unit 1004 is disposed. In arc-extinguishing frame 1005A, internal wall 1052A is formed to the right of the central part in the left-right direction. Thus, circulating flow path 1050A is formed such that width L2 on the right side of internal wall 1052A is smaller than width L1 on the left side of internal wall 1052A, and different sectional areas are provided on the right and left sides of internal wall 1052A. Since an arc is generated in the space on the left side of internal wall 1052A in circulating flow path 1050A, width L1 is set to such a dimension that the arc does not contact arc-extinguishing frame 1005. In contrast, no arc is generated in the space on the right side of internal wall 1052A in circulating flow path 1050A, but air only needs to flow to an extent enough to suppress an increase in air pressure in a direction in which the arc is extended with respect to contact unit 1004. Thus, the configuration with width L2 set to be smaller than width L1 has small influence on the arc extinguishment. Since width L2 is set to be smaller than width L1, arc-extinguishing frame 1005A has a smaller width in the left-right direction than that of arc-extinguishing frame 1005.

Accordingly, in contact device 1001 according to the present exemplary embodiment, circulating flow path 1050A includes a space having width L1 (first space) and a space having width L2 (second space). Contact unit 1004 (refer to FIG. 3) is disposed in the first space. A sectional area of the second space in the direction of action is smaller than a sectional area of the first space.

This configuration suppresses interference of arc-extinguishing frame 1005A with any other component, and achieves downsizing of contact device 1001.

An arc-extinguishing member (not illustrated) configured to discharge arc-extinguishing gas including hydrogen as a primary component when heated may be provided on a sidewall or internal wall 1052 of arc-extinguishing frame 1005. In this case, circulating flow path 1050 is preferably formed with a smaller width on the left side of internal wall 1052 so as to facilitate contact of an arc with the arc-extinguishing member.

In arc-extinguishing frame 1005, only a part that an arc potentially contacts needs to be made of an insulator having an electric insulation property, and a part that no arc potentially contacts may be made of material other than an insulator. For example, as illustrated in FIG. 5, in arc-extinguishing frame 1005B, sidewall 1501 on a right side of internal wall 1052B is made of metal. In other words, in arc-extinguishing frame 1005B, sidewall 1501 that no arc potentially contacts is made of metal having a strength higher than those of insulators such as resin and ceramic. Accordingly, arc-extinguishing frame 1005B can have an improved strength as compared to that of arc-extinguishing frame 1005 made of an insulator only.

Above-described contact device 1001 includes one contact unit 1004, but may include two contact units 1004 or more.

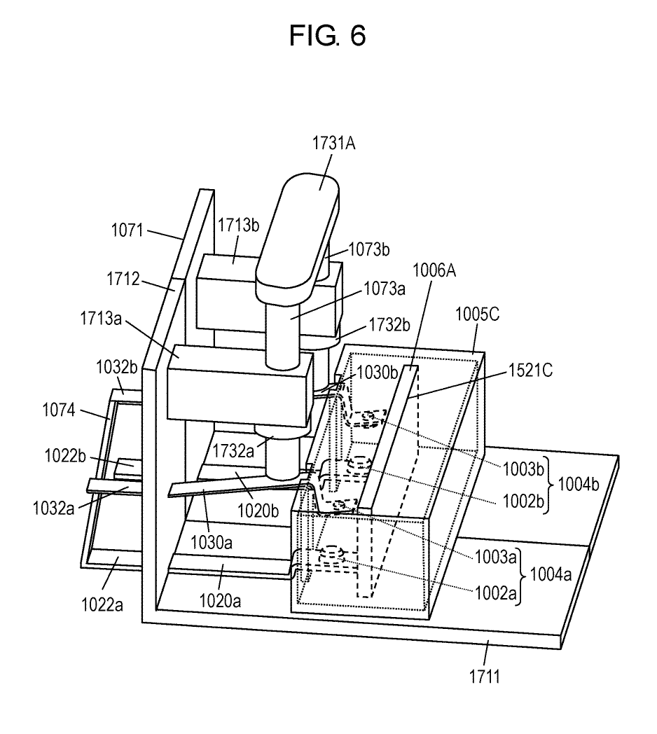

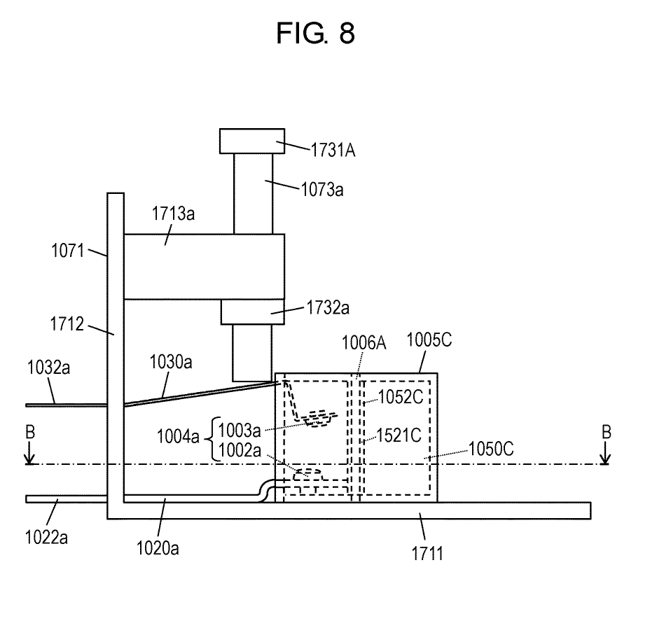

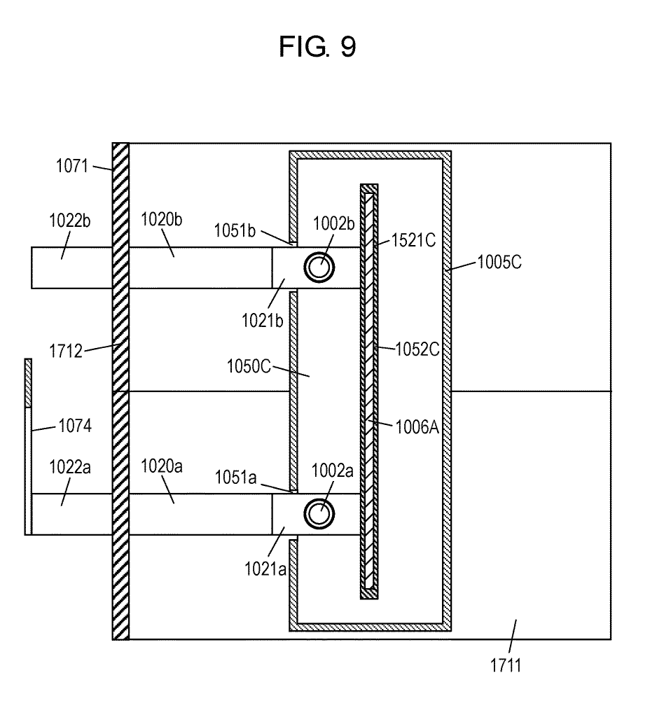

FIGS. 6 to 9 illustrate a modification of contact device 1001 including two contact units 1004. FIG. 9 is a sectional view taken along line B-B in FIG. 8. In FIG. 6 to FIG. 9, cover 1072 is omitted.

Contact device 1001 according to the present modification includes two sets of contact unit 1004 (fixed contact 1002, movable contact 1003), fixed contact plate 1020, movable contact plate 1030, movable shaft 1073, and holding part 1713. The sets of contact unit 1004 (fixed contact 1002, movable contact 1003), fixed contact plate 1020, movable contact plate 1030, movable shaft 1073, and holding part 1713 are provided side by side in the front-rear direction. In order to distinguish the two sets of contact unit 1004 (fixed contact 1002, movable contact 1003), fixed contact plate 1020, movable contact plate 1030, movable shaft 1073, and holding part 1713 in the following description, components of the set on the front side are denoted by reference numerals followed by “a”, and components of the set on the rear side are denoted by reference numerals followed by “b”.

In contact device 1001 according to the present modification, upper ends of movable shaft 1073a and movable shaft 1073b are coupled with each other through first flange part 1731A so as to simultaneously close or open two contact units 1004a and 1004b.

Arc-extinguishing frame 1005C is provided around two contact units 1004a and 1004b. Hole 1051a for housing contact unit 1004a in arc-extinguishing frame 1005C and hole 1051b for housing contact unit 1004b in arc-extinguishing frame 1005C are formed in a left sidewall of arc-extinguishing frame 1005C. Arc-extinguishing frame 1005C includes circulating flow path 1050C formed by internal wall 1052C.

Magnet 1006A is inserted in hole 1521C formed in internal wall 1052C of arc-extinguishing frame 1005C, applying magnetic field toward the left direction on contact units 1004a and 1004b.

As described above, contact device 1001 according to the present modification includes two contact units 1004a and 1004b, and for example, arc-extinguishing frame 1005C and magnet 1006A are shared by two contact units 1004a and 1004b. Accordingly, the present modification can achieve space saving and reduction in cost as compared to a case in which a plurality of contact devices 1001 each including one contact unit 1004 are used.

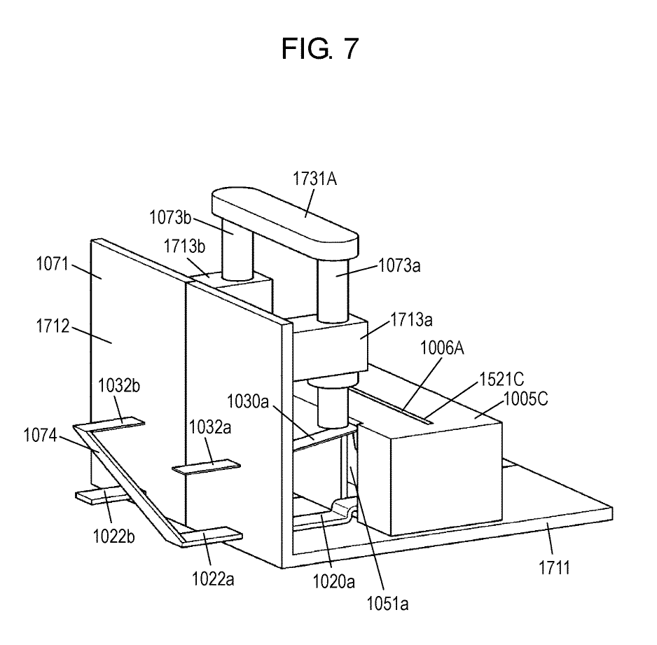

As illustrated in FIG. 7, terminal part 1022a of fixed contact plate 1020a and terminal part 1032b of movable contact plate 1030b are short-circuited through conducting member 1074. Accordingly, two contact units 1004a and 1004b are serially connected with each other. Although conducting member 1074 is exposed from side plate 1712, side plate 1712 may be formed by insert molding of conducting member 1074.

The serial connection of two contact units 1004a and 1004b leads to division of voltage applied between fixed contact 1002 and movable contact 1003 at contact opening as compared to the configuration including only one contact unit 1004, thereby achieving an improved voltage resistance of contact device 1001.

A direction of a force (Lorentz force) acting on a current flowing between fixed contact 1002 and movable contact 1003 due to an applied magnetic field is identical between two contact units 1004a and 1004b in the circumferential direction of circulating flow path 1050C. In other words, the directions of currents flowing through contact units 1004a and 1004b are identical to each other, and thus arcs generated at contact units 1004a and 1004b can be extended in the same direction. Thus, a direction of an air current generated by an arc generated at contact unit 1004a, and a direction of an air current generated by an arc generated at contact unit 1004b are identical to each other. Accordingly, air flows only in one direction through circulating flow path 1050C, thereby achieving an efficient flow of air and thus facilitating the extension of an arc to extinguish the arc faster. In addition, arcs generated at contact units 1004a and 1004b are extended in the same direction, thereby preventing contact between the arcs.

In contact device 1001, two contact units 1004a and 1004b may be connected with each other in parallel. Contact units 1004a and 1004b are connected with each other in parallel by short-circuiting terminal part 1022a of fixed contact plate 1020a and terminal part 1022b of fixed contact plate 1020b, and also short-circuiting terminal part 1032a of movable contact plate 1030a and terminal part 1032b of movable contact plate 1030b.

The parallel connection of two contact units 1004a and 1004b leads to division of current flowing between fixed contact 1002 and movable contact 1003 at contact closing as compared to the configuration including only one contact unit 1004, thereby achieving an improved current capacity of contact device 1001.

The directions of currents flowing through contact units 1004a and 1004b are identical to each other, and thus arcs generated at contact units 1004a and 1004b can be extended in the same direction. This facilitates the extension of the arc to extinguish the arc faster. In addition, contact between arcs can be prevented.

Although one magnet 1006A is used to apply a magnetic field on contact units 1004a and 1004b in one direction in the above-described configuration, two magnets may be used to apply magnetic fields on respective contact units 1004a and 1004b. This allows the magnetic fields applied to respective contact units 1004a and 1004b to have directions different from each other. Accordingly, arcs generated at contact units 1004a and 1004b can be extended in the same direction along the circumferential direction of circulating flow path 1050C even when current flows in directions different between contact units 1004a and 1004b.

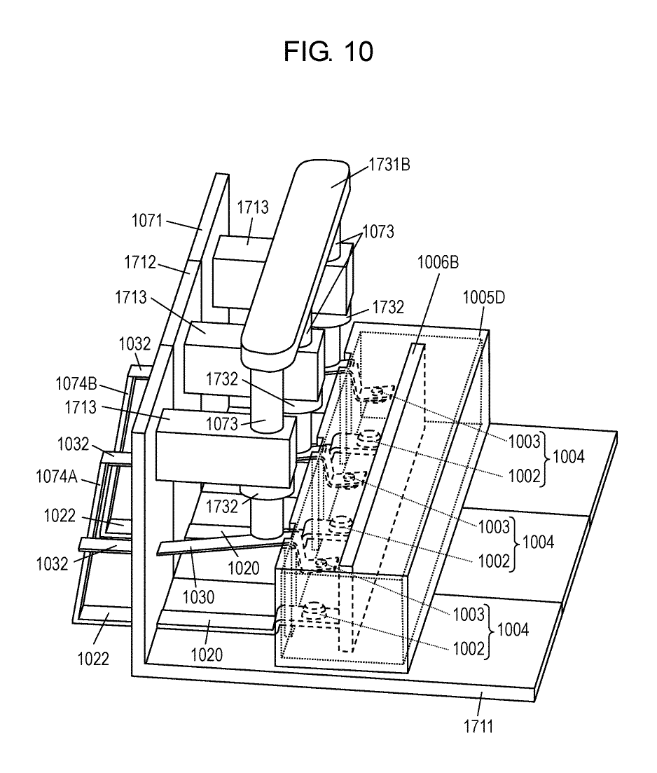

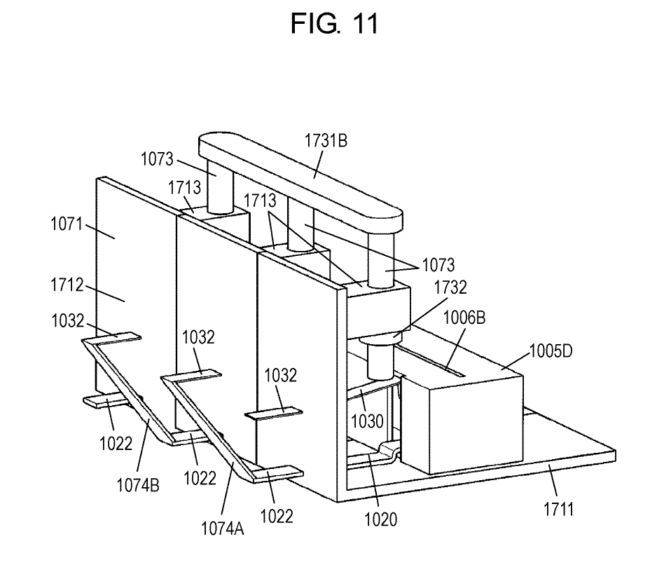

The number of contact units 1004 is not limited to two, but contact device 1001 may include a larger number of contact units 1004. As illustrated in FIGS. 10 and 11, contact device 1001 includes three contact units 1004. This contact device 1001 includes arc-extinguishing frame 1005D provided around three contact units 1004 and magnet 1006B configured to apply a magnetic field to three contact units 1004. Upper ends of three movable shafts 1073 are coupled with each other through first flange part 1731B. Terminal part 1022 of fixed contact plate 1020 on the front side and terminal part 1032 of movable contact plate 1030 in a central part are short-circuited through conducting member 1074A, and terminal part 1022 of fixed contact plate 1020 in the central part and terminal part 1032 of movable contact plate 1030 on the rear side are short-circuited through conducting member 1074B. Accordingly, three contact units 1004 are serially connected with each other, and an arc generated at each contact unit 1004 is extended in an identical direction, thereby facilitating the extension of the arc to extinguish the arc faster.

### Second Exemplary Embodiment

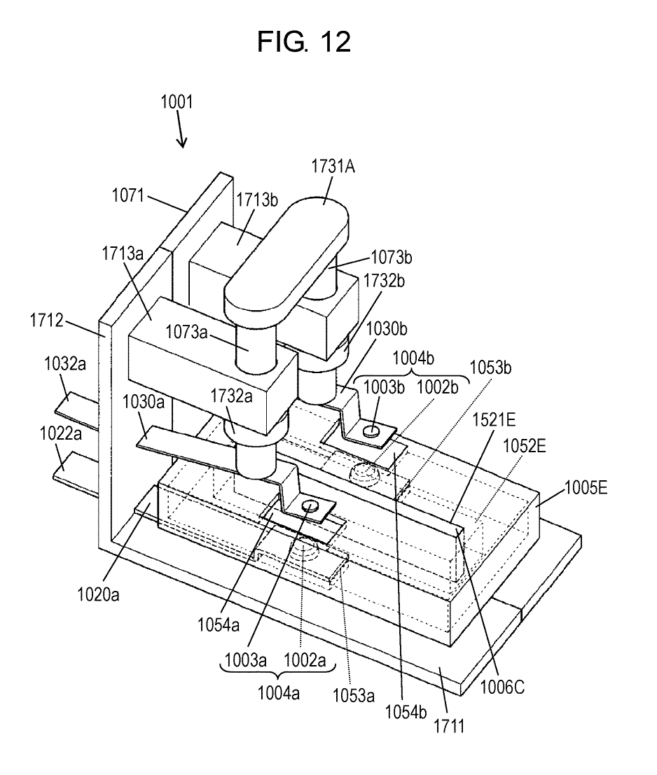

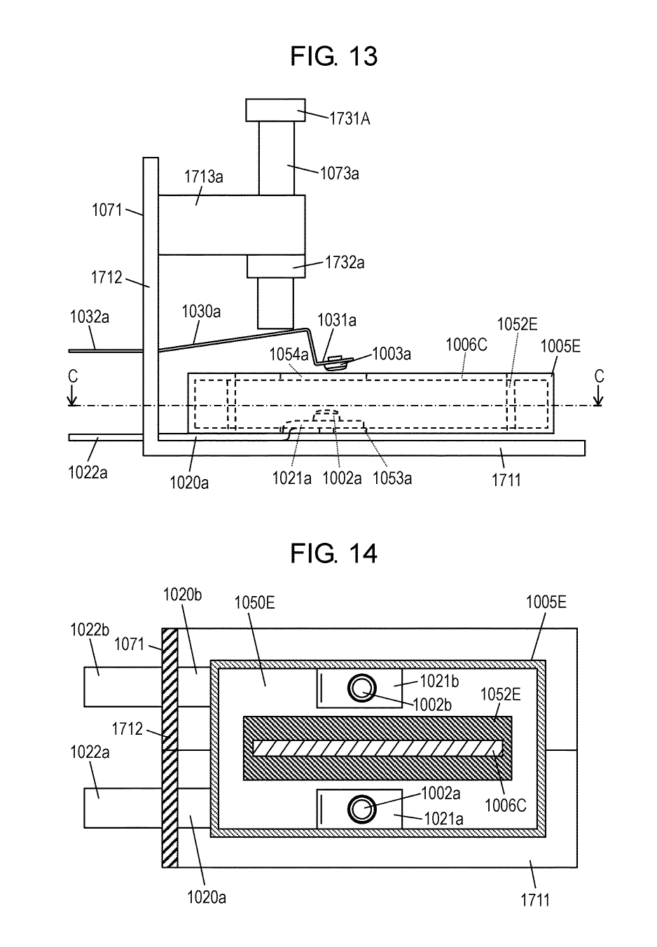

FIG. 12 illustrates an external perspective view of contact device 1001 according to the present exemplary embodiment, and FIG. 13 illustrates a front view of contact device 1001. FIG. 14 illustrates a sectional view taken along line C-C in FIG. 13. Any identical component as in the first exemplary embodiment is denoted by an identical reference numeral, and description thereof is omitted. In the present exemplary embodiment, illustration of cover 1072 is omitted.

Contact device 1001 according to the present exemplary embodiment is different from contact device 1001 according to the first exemplary embodiment in the structure of arc-extinguishing frame 1005E.

Arc-extinguishing frame 1005E is formed in a rectangular parallelepiped shape whose longitudinal direction is in the left-right direction.

Arc-extinguishing frame 1005E with internal wall 1052E whose thickness direction is in the front-rear direction forms rectangular circulating flow path 1050E whose longitudinal direction is in the left-right direction.

Rectangular hole 1053a through which fixed contact plate 1020a is disposed, and rectangular hole 1053b through which fixed contact plate 1020b is disposed are formed in a central part on a lower surface of arc-extinguishing frame 1005E in the left-right direction. Hole 1053a is formed on the front side of internal wall 1052E, and hole 1053b is formed on the rear side of internal wall 1052E. When fixed contact plate 1020a is disposed through hole 1053a, contact holding part 1021a and fixed contact 1002a are housed in arc-extinguishing frame 1005E. When fixed contact plate 1020b is disposed through hole 1053b, contact holding part 1021b and fixed contact 1002b are housed in arc-extinguishing frame 1005E.

Hole 1054a through which movable contact 1003a is disposed, and hole 1054b through which movable contact 1003b is disposed are formed in a central part of an upper surface of arc-extinguishing frame 1005E in the left-right direction. When movable shaft 1073a is moved in the down direction and movable contact plate 1030a is bent in the down direction, movable contact 1003a is brought into contact with fixed contact 1002a through hole 1054a. Similarly, when movable shaft 1073b is moved in the down direction and movable contact plate 1030b is bent in the down direction, movable contact 1003b is brought into contact with fixed contact 1002b through hole 1054b.

Magnet 1006C is formed in a plate whose thickness direction is in the front-rear direction and longitudinal direction is in the left-right direction, and is inserted in hole 1521E formed in internal wall 1052E of arc-extinguishing frame 1005E. Accordingly, magnet 1006C is disposed between contact units 1004a and 1004b in the front-rear direction. In the present exemplary embodiment, magnet 1006C applies a magnetic field toward the rear direction on contact units 1004a and 1004b.

In the present exemplary embodiment, terminal part 1032a of movable contact plate 1030a and terminal part 1032b of movable contact plate 1030b are short-circuited, and fixed contact plate 1020a and fixed contact plate 1020b are configured to be short-circuited when contact units 1004a and 1004b are closed. Accordingly, current flows in contact units 1004a and 1004b in opposite directions. For example, when current flows from fixed contact 1002a toward movable contact 1003a, current flows from movable contact 1003b toward fixed contact 1002a. In this case, an arc generated at contact unit 1004a is extended toward the left direction, and an arc generated at contact unit 1004b is extended toward the right direction. In other words, a direction of a force (Lorentz force) acting on current flowing between fixed contact 1002 and movable contact 1003 due to an applied magnetic field is identical between two contact units 1004a and 1004b in the circumferential direction of circulating flow path 1050E. Thus, in arc-extinguishing frame 1005, air currents generated by heat of arcs generated at contact units 1004a and 1004b have an identical (in FIG. 14, clockwise) direction along the circumferential direction of circulating flow path 1050E. Accordingly, air can be efficiently circulated, thereby facilitating the extension of the arc to extinguish the arc faster.

Since magnet 1006C is disposed between contact units 1004a and 1004b in the front-rear direction, magnet 1006C is located at a shorter distance to contact units 1004a and 1004b, thereby applying a stronger magnetic field on contact units 1004a and 1004b. This enables further extension of an arc to extinguish the arc faster.

In the present exemplary embodiment, since fixed contact plate 1020 and movable contact plate 1030 are each formed in a plate long in the left-right direction, and magnet 1006C is provided such that its longitudinal direction is in the left-right direction, the longitudinal directions of fixed contact plate 1020, movable contact plate 1030, and magnet 1006C are identical to each other. Accordingly, an arc generated at contact unit 1004 is extended in the left-right direction, which is identical to the longitudinal directions of fixed contact plate 1020 and movable contact plate 1030, and thus arc-extinguishing frame 1005E whose longitudinal direction is in the left-right direction can be disposed between fixed contact plate 1020 and movable contact plate 1030 in the up-down direction. This allows such effective use of the space in case 1007 that contact device 1001 has a small width in the front-rear direction as compared to a case in which arc-extinguishing frame 1005C (refer to FIGS. 6 to 9) whose longitudinal direction is in the front-rear direction is used, thereby thinning contact device 1001.

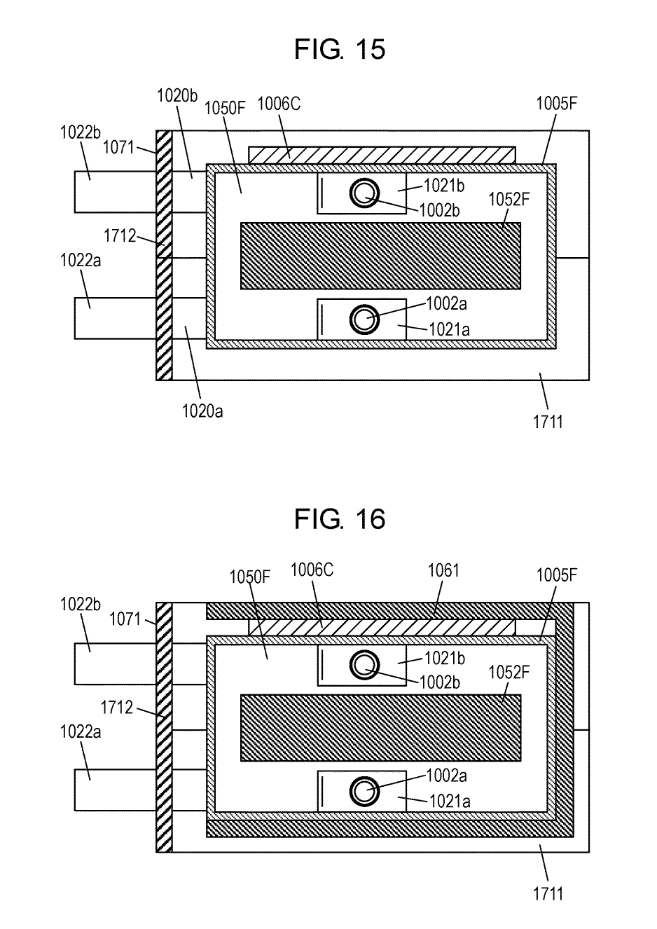

A position at which magnet 1006C is disposed is not limited to the position surrounded by circulating flow path 1050E. For example, as illustrated in FIG. 15, magnet 1006C is provided outside of circulating flow path 1050F, specifically, on the rear side of arc-extinguishing frame 1005F. Accordingly, a hole to which magnet 1006C is inserted does not need to be formed in internal wall 1052F of arc-extinguishing frame 1005F, and thus the structure of arc-extinguishing frame 1005F is simplified.

As illustrated in FIG. 16, contact device 1001 may include yoke 1061. Yoke 1061 is formed in an U shape having an opening on a left side, and is provided around magnet 1006C and arc-extinguishing frame 1005F. This yoke 1061 aligns directions of magnetic fields applied to contact units 1004a and 1004b and strengthens the magnetic fields applied to contact units 1004a and 1004b. This achieves further extension of an arc, thereby extinguishment of the arc faster. Although contact unit 1004a is provided at a position further separated from magnet 1006C than contact unit 1004b, yoke 1061 can maintain the strength of the magnetic field applied to contact unit 1004a.

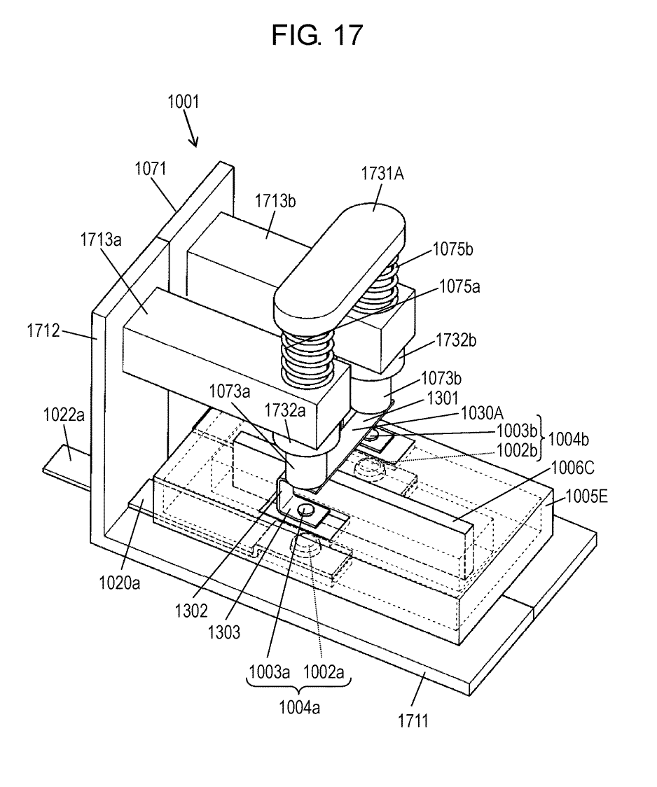

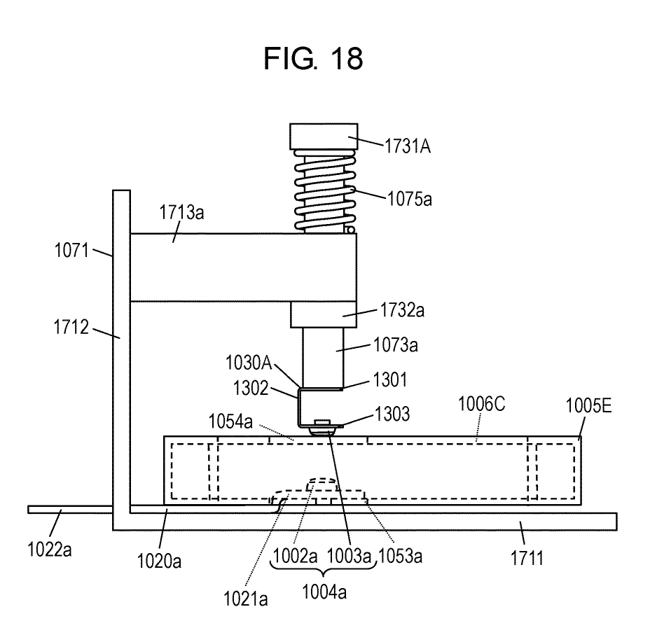

In the above-described configuration, two movable contact plates 1030a and 1030b are used to short-circuit two fixed contact plates 1020a and 1020b at contact closing, but the present invention is not limited thereto. For example, as illustrated in FIGS. 17 and 18, one movable contact plate 1030A may be used to short-circuit two fixed contact plates 1020a and 1020b at contact closing. Movable contact plate 1030A is a bent metal plate. Movable contact plate 1030A includes first part 1301 that contacts lower ends of movable shafts 1073a and 1073b, second part 1302 extending in the down direction from front and rear ends at a left end of first part 1301, and third part 1303 extending in the right direction from a lower end of second part 1302. Third part 1303 functions as a contact holding part, below which movable contact 1003 is provided.

Movable shaft 1073a is provided through coil spring 1075a between holding part 1713a and first flange part 1731A, and movable shaft 1073b is provided through coil spring 1075b between holding part 1713b and first flange part 1731A. Repelling force due to coil springs 1075a and 1075b presses first flange part 1731A upward so as to hold movable contact 1003 at the closed position at which movable contact 1003 is separate from fixed contact 1002. Then, downward force applied to movable shafts 1073a and 1073b by electromagnetic device 1010 (refer to FIG. 3) moves movable shafts 1073a and 1073b and movable contact plate 1030A in the down direction. Accordingly, movable contact 1003 is held at the closed position at which movable contact 1003 is in contact with fixed contact 1002, so that fixed contact plates 1020a and 1020b are short-circuited. In the example illustrated in FIGS. 17 and 18, coil spring 1075 is provided between first flange part 1731A and holding part 1713, but may be provided between first flange part 1731A and cover 1072 (refer to FIGS. 2 and 3).

### Third Exemplary Embodiment

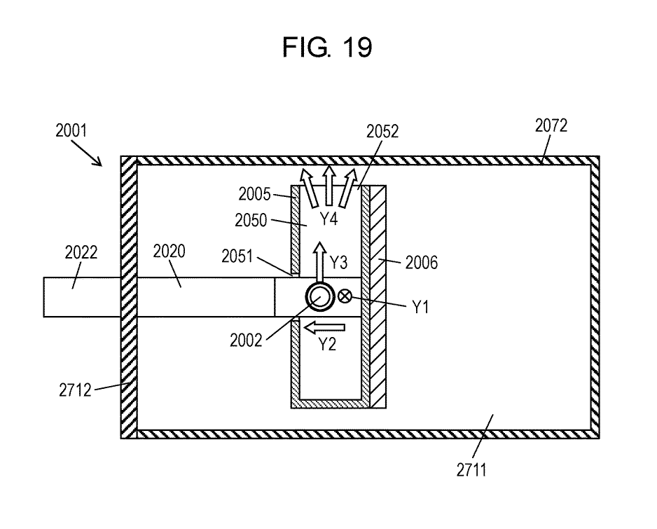

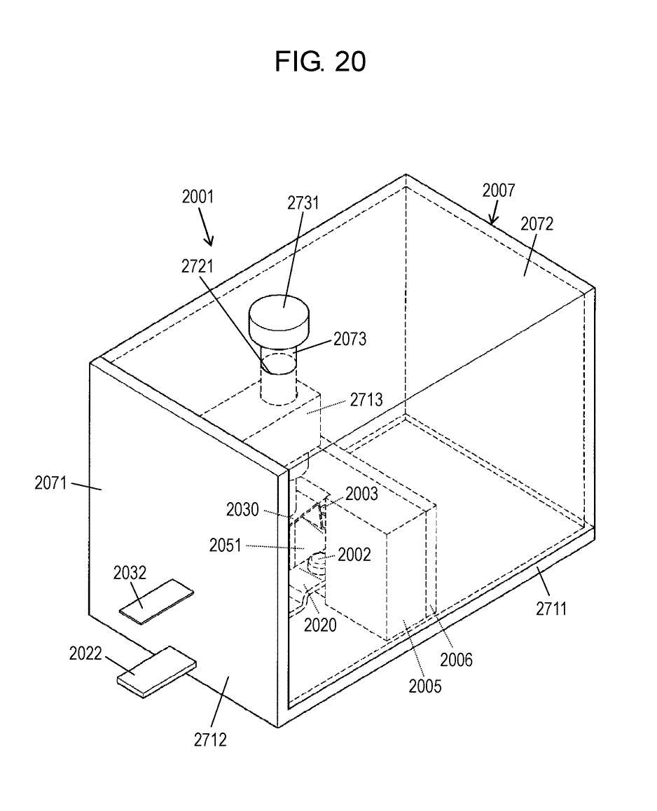

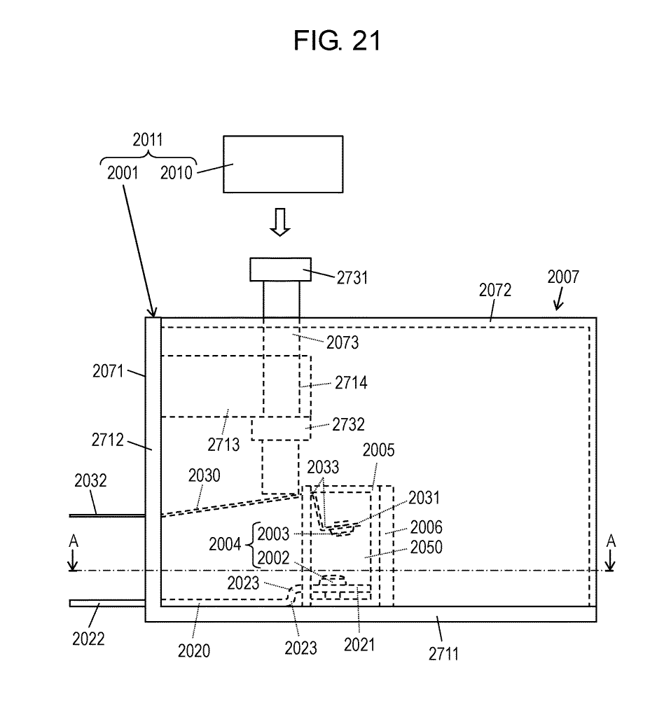

FIG. 20 illustrates an external perspective view of contact device 2001 according to the present exemplary embodiment, and FIG. 21 illustrates a front view of contact device 2001. FIG. 19 illustrates a sectional view taken along line A-A in FIG. 21. As illustrated in FIGS. 19 to 21, contact device 2001 according to the present exemplary embodiment includes contact unit 2004 including fixed contact 2002 and movable contact 2003 configured to move between a closed position at which movable contact 2003 is in contact with fixed contact 2002 and an open position at which movable contact 2003 is separate from fixed contact 2002, magnet 2006 configured to generate a magnetic field, and arc-extinguishing frame 2005 as an exemplary arc-extinguishing body.

The following describes a configuration of contact device 2001 according to the present exemplary embodiment in detail with reference to FIGS. 19 to 21. Up-down and left-right directions in FIG. 21 are defined as up-down and left-right directions in the following description. The front-rear direction is defined to be a direction orthogonal to the up-down and left-right directions, and specifically, the front direction is defined to be a direction away from the drawing plane of FIG. 21 (the down direction in FIG. 19), and the rear direction is defined to be a direction toward the drawing plane (the up direction in FIG. 19).

The following describes an example in which electromagnetic relay 2011 includes contact device 2001 according to the present exemplary embodiment and electromagnetic device 2010 configured to move movable contact 2003 as illustrated in FIG. 21. Usage of contact device 2001 is not limited to electromagnetic relay 2011, and contact device 2001 may be used in, for example, a switch or a breaker (circuit breaker).

In contact device 2001 according to the present exemplary embodiment, contact unit 2004 (fixed contact 2002, movable contact 2003), arc-extinguishing frame 2005, and magnet 2006 are housed in rectangular parallelepiped case 2007. Case 2007 includes body 2071 and cover 2072 attached to body 2071.

Body 2071 is formed in an L shape with bottom plate 2711 and side plate 2712, serving as a bottom part and a left sidewall of case 2007. Cover 2072 is formed in a rectangular parallelepiped shape having a hollow structure with openings on a lower surface and a left surface, and is attached to body 2071 such that body 2071 covers the openings on the lower surface and the left surface.

Fixed contact 2002 is provided to rectangular fixed contact plate 2020 including contact holding part 2021, terminal part 2022, and curved parts 2023. Fixed contact plate 2020 is a metal plate whose longitudinal direction is in the left-right direction and thickness direction is in the up-down direction, and is provided along bottom plate 2711 of body 2071. Fixed contact plate 2020 is formed including two curved parts 2023 such that contact holding part 2021 on a right end side is separate from bottom plate 2711. Fixed contact 2002 is swaged on contact holding part 2021 so that fixed contact 2002 is fixed to an upper surface of contact holding part 2021. Fixed contact plate 2020 is provided penetrating side plate 2712, and terminal part 2022 protruding from side plate 2712 to a left side is electrically connected with, for example, a power source (not illustrated). In the present exemplary embodiment, fixed contact plate 2020 and fixed contact 2002 are separately provided, but fixed contact plate 2020 and fixed contact 2002 may be integrally provided by, for example, forming fixed contact 2002 through embossing of fixed contact plate 2020.

Movable contact 2003 is provided to rectangular movable contact plate 2030 including contact holding part 2031, terminal part 2032, and curved parts 2033. Movable contact plate 2030 is a metal plate whose longitudinal direction is in the left-right direction and thickness direction is in the up-down direction, and is fixed to side plate 2712 such that a lower surface of movable contact plate 2030 faces an upper surface of fixed contact plate 2020. Movable contact plate 2030 is formed including two curved parts 2033 such that contact holding part 2031 on a right end side is close to bottom plate 2711.

Movable contact 2003 is swaged on contact holding part 2031 so that movable contact 2003 is fixed on a lower surface of contact holding part 2031 at a position facing fixed contact 2002 in the up-down direction. Movable contact plate 2030 is provided penetrating side plate 2712, and terminal part 2032 protruding from side plate 2712 to a left side is electrically connected with, for example, a load (not illustrated). Movable contact plate 2030 is also used as a plate spring having elasticity in the up-down direction, and the elasticity of movable contact plate 2030 is used for contact closing at which movable contact 2003 and fixed contact 2002 are in contact with each other, and for contact opening at which movable contact 2003 and fixed contact 2002 are separate from each other. In the present exemplary embodiment, movable contact plate 2030 and movable contact 2003 are separately provided, but may be integrally provided by, for example, forming movable contact 2003 through embossing of movable contact plate 2030.

Movable contact plate 2030 is bent by round movable shaft 2073 in the down direction, so that contact holding part 2031 and movable contact 2003 move in the down direction. Movable shaft 2073 is movably held in the up-down direction by holding part 2713 provided protruding from side plate 2712 of case 2007 to a right side, and a lower end of movable shaft 2073 is in contact with an upper surface of movable contact plate 2030.

Holding part 2713 is formed in a rectangular parallelepiped shape and provided at a position above movable contact plate 2030 on side plate 2712. Holding part 2713 is provided with hole 2714 penetrating in the up-down direction, through which movable shaft 2073 is movably held in the up-down direction. Hole 2721 penetrating in the up-down direction is also formed in an upper surface of cover 2072, and movable shaft 2073 is provided such that movable shaft 2073 penetrates hole 2721 of cover 2072. In other words, movable shaft 2073 is held while protruding from case 2007.

First flange part 2731 is formed at an upper end of movable shaft 2073, and a lowest position of movable shaft 2073 is a position at which a lower surface of first flange part 2731 is in contact with the upper surface of cover 2072. In addition, second flange part 2732 of movable shaft 2073 is formed at a position below holding part 2713, and a highest position of movable shaft 2073 is a position at which an upper surface of second flange part 2732 is in contact with a lower surface of holding part 2713.

Movable shaft 2073 is moved in the down direction by electromagnetic device 2010 (refer to FIG. 21). Electromagnetic device 2010 has a conventionally known configuration in which, for example, an excitation coil and a movable iron core not illustrated are included, and the movable iron core configured to be moved in the down direction through magnetic flux generated by the excitation coil when energized is coupled with movable shaft 2073. Thus, when the excitation coil is energized to move the movable iron core in the down direction, movable shaft 2073 is provided with force in the down direction, and is moved in the down direction. The configuration of electromagnetic device 2010 is not limited to the above-described configuration.

When the excitation coil is energized to move movable shaft 2073 in the down direction, movable contact plate 2030 is bent in the down direction so that contact holding part 2031 and movable contact 2003 move in the down direction. Accordingly, movable contact 2003 is brought into contact with fixed contact 2002, so that movable contact plate 2030 and fixed contact plate 2020 have conduction therebetween.

Since movable contact plate 2030 has elasticity in the up-down direction, an upward force due to a restoring force for returning movable contact plate 1030 from the bent state to the original state acts to separate movable contact 2003 from fixed contact 2002. When the energization of the excitation coil is stopped and the downward force on movable shaft 2073 is canceled, the restoring force of movable contact plate 2030 moves contact holding part 2021 in the up direction, so that movable contact 2003 separates from fixed contact 2002.

In this manner, movable contact 2003 moves in the up-down direction between the closed position at which movable contact 2003 is in contact with fixed contact 2002 and the open position at which movable contact 2003 is separate from fixed contact 2002.

At the contact opening at which movable contact 2003 is separate from fixed contact 2002, an arc is potentially generated between movable contact 2003 and fixed contact 2002. In order to extinguish this arc, contact device 2001 according to the present exemplary embodiment includes magnet 2006.

Magnet 2006 is formed in a plate shape whose thickness direction is in the left-right direction, and is disposed on the right side of contact unit 2004. Magnet 2006 applies a magnetic field to a space including contact unit 2004. This magnetic field exerts a Lorentz force on an arc to extend the arc, thereby extinguishing the arc. In the present exemplary embodiment, current flows from movable contact 2003 toward fixed contact 2002, and a magnetic field toward the left direction is applied to the space including contact unit 2004. In this case, the arc is extended toward the rear direction by the magnetic field. In FIG. 19, arrow Y1 represents a direction in which the current flows, arrow Y2 represents a direction of the magnetic field, and arrow Y3 represents a direction in which the arc is extended.

The arc has a high temperature and generates gas including metal in some cases. Contact device 2001 according to the present exemplary embodiment includes arc-extinguishing frame 2005 so as to prevent scattering of, for example, metal included in the gas, and further to prevent contact of an arc with magnet 2006.

Arc-extinguishing frame 2005 is an insulator, such as resin or ceramic, having an electric insulation property, formed in a rectangular parallelepiped shape, and includes flow path 2050 inside in the front-rear direction. Arc-extinguishing frame 2005 is provided around contact unit 2004. In order to house contact unit 2004 in arc-extinguishing frame 2005, rectangular hole 2051 is formed in a range from an upper end to a lower end of a central part in the front-rear direction on a left sidewall of arc-extinguishing frame 2005. Fixed contact plate 2020 and movable contact plate 2030 are disposed through hole 2051 so as to house contact unit 2004 (movable contact 2003, fixed contact 2002) in arc-extinguishing frame 2005. Hole 2051 is formed in a rectangle whose longitudinal direction is in the up-down direction, and movable contact plate 2030 can move in the up-down direction in hole 2051, and thus movable contact 2003 can move between the closed position and the open position. Magnet 2006 is disposed outside (right side) of arc-extinguishing frame 2005.

As described above, an arc has a high temperature, air in arc-extinguishing frame 2005 is heated to expand due to heat of the arc. In the present exemplary embodiment, when the arc is extended toward the rear direction by a magnetic field, air on the rear side of contact unit 2004 in arc-extinguishing frame 2005 is more heated to expand, in particular.

Arc-extinguishing frame 2005 according to the present exemplary embodiment includes ventilation hole 2052 in a rear surface located in a direction in which the arc is extended. Ventilation hole 2052 is formed in the entire rear surface of arc-extinguishing frame 2005. Thus, air expanded by heat of an arc flows toward the rear direction along flow path 2050, and can be ejected out of arc-extinguishing frame 2005 through ventilation hole 2052. In FIG. 19, arrow Y4 represents a flow of air ejected from arc-extinguishing frame 2005.

As described above, contact device 2001 according to the present exemplary embodiment includes contact unit 2004 including fixed contact 2002 and movable contact 2003, magnet 2006 configured to generate a magnetic field, and arc-extinguishing frame 2005 (arc-extinguishing body). Movable contact 2003 moves between the closed position at which movable contact 2003 is in contact with fixed contact 2002 and the open position at which movable contact 2003 is separate from fixed contact 2002. The direction of action (the front-rear direction) is a direction intersecting with a direction of a magnetic field applied to contact unit 2004 (the left direction) and with a direction in which movable contact 2003 moves (the up-down direction). Arc-extinguishing frame 1005 (arc-extinguishing body) forms an arc-extinguishing space in the direction of action.

Contact device 1001 according to the present exemplary embodiment, which has the above-described configuration, can easily extend an arc to extinguish the arc faster.

Contact device 2001 according to the present exemplary embodiment further includes the following configuration. The arc-extinguishing body includes arc-extinguishing frame 2005 that forms flow path 2050 communicating with at least one side (the rear side) with respect to the space including contact unit 2004 in the direction of action (the front-rear direction). Arc-extinguishing frame 2005 include ventilation hole 2052 on a surface on at least one side (the rear side) of contact unit 2004 among surfaces facing contact unit 2004 in the direction of action (the front-rear direction).

In contact device 2001 according to the present exemplary embodiment, which includes the above-described configuration, air in arc-extinguishing frame 2005 is ejected through ventilation hole 2052 when heated by heat of an arc. Arc-extinguishing frame 2005, which includes ventilation hole 2052 formed in the rear surface facing a direction in which the arc is extended (the rear direction) with respect to contact unit 2004, can efficiently eject the air, thereby suppressing an increase in air pressure in arc-extinguishing frame 2005. Accordingly, the extension of the arc can be prevented from being encumbered by the increase in air pressure inside arc-extinguishing frame 2005. This facilitates the extension of the arc to extinguish the arc fast. The fast extinguishment of the arc enables a fast electric break between fixed contact 2002 and movable contact 2003 at contact opening, thereby achieving improved breaking performance of contact device 2001.

In arc-extinguishing frame 2005 according to the present exemplary embodiment, the entire rear surface is opened through one ventilation hole 2052, but a plurality of holes may be formed in the rear surface.

Arc-extinguishing frame 2005 is provided around contact unit 2004. This configuration can suppress scattering of, for example, metal included in gas generated by an arc generated at contact unit 2004, thereby preventing adhesion of the metal on, for example, fixed contact 2002 and movable contact 2003.

Arc-extinguishing frame 2005 does not necessarily need to be integrally formed, but may include a combination of a plurality of divided components. This configuration is useful when it is convenient to have a plurality of components at assembly of contact device 2001 and manufacturing of arc-extinguishing frame 2005.

The following describes modifications of contact device 2001 according to the present exemplary embodiment. Any components according to the modifications of contact device 2001 are denoted by reference numerals followed by A, B, C . . . to distinguish the components.

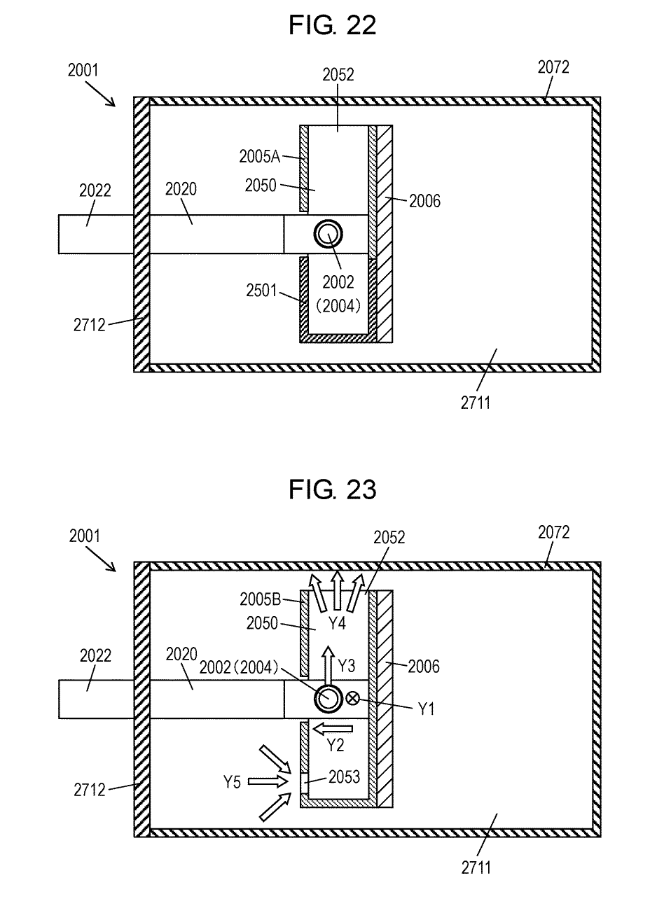

In arc-extinguishing frame 2005, only a part that an arc potentially contacts needs to be made of an insulator having an electric insulation property, and a part that no arc potentially contacts may be made of material other than an insulator. For example, as illustrated in FIG. 22, in arc-extinguishing frame 2005A, sidewall 2501 on the front side of contact unit 2004 is made of metal. In other words, in arc-extinguishing frame 2005A, sidewall 2501 that no arc potentially contacts is made of metal having a strength higher than those of insulators such as resin and ceramic. Accordingly, arc-extinguishing frame 2005A can have an improved strength as compared to that of arc-extinguishing frame 2005 made of an insulator only.

In arc-extinguishing frame 2005, a hole (air intake hole) may be provided in a surface on an opposite side (the front side) to ventilation hole 2052 with respect to contact unit 2004 in the front-rear direction (the direction of action). As illustrated in FIG. 23, in arc-extinguishing frame 2005B, air intake hole 2053 is formed in a left sidewall on the front side of contact unit 2004. In arc-extinguishing frame 2005B including air intake hole 2053, air is taken into arc-extinguishing frame 2005B through air intake hole 2053 when air is ejected through ventilation hole 2052. In FIG. 23, arrow Y5 represents a flow of air taken in arc-extinguishing frame 2005. As described above, since arc-extinguishing frame 2005B includes air intake hole 2053 serving as an air inlet, the intake and ejection of air can be efficiently performed, thereby facilitating the extension of an arc to extinguish the arc faster.

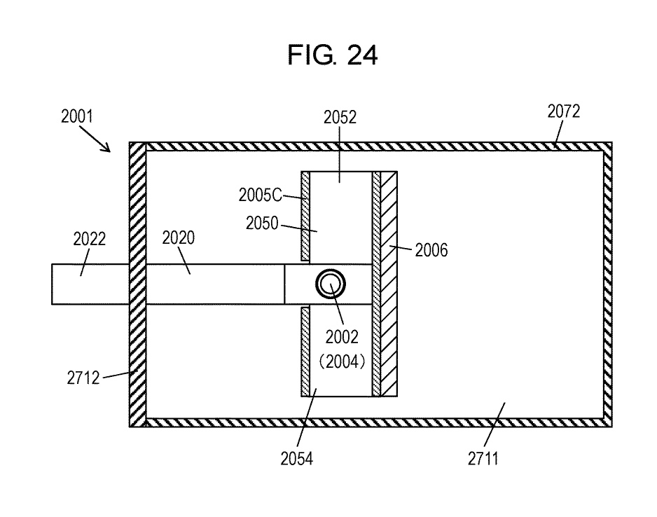

Arc-extinguishing frame 2005 may have a configuration that a ventilation hole is provided in surfaces of arc-extinguishing frame 2005 on both sides of contact unit 2004 in the front-rear direction (the direction of action). As illustrated in FIG. 24, arc-extinguishing frame 2005C includes ventilation hole 2052 in a rear surface and ventilation hole 2054 in a front surface. Ventilation hole 2054 is formed in the entire front surface of arc-extinguishing frame 2005C. When current flows from movable contact 2003 toward fixed contact 2002, an arc is extended toward the rear direction, and thus air in arc-extinguishing frame 2005C is ejected through ventilation hole 2052, and air is taken into arc-extinguishing frame 2005B through ventilation hole 2054. In contrast, when current flows from fixed contact 2002 toward movable contact 2003, an arc is extended toward the front direction, and thus air in arc-extinguishing frame 2005C is ejected through ventilation hole 2054, and air is taken into arc-extinguishing frame 2005B through ventilation hole 2052. In other words, since the front surface and the rear surface of arc-extinguishing frame 2005C have openings, the intake and ejection of air can be efficiently performed irrespective of a direction of current flowing between movable contact 2003 and fixed contact 2002. Accordingly, a direction in which current flows does not need to be restricted, and the extension of the arc can be facilitated to extinguish the arc faster irrespective of a direction of current flowing between movable contact 2003 and fixed contact 2002.

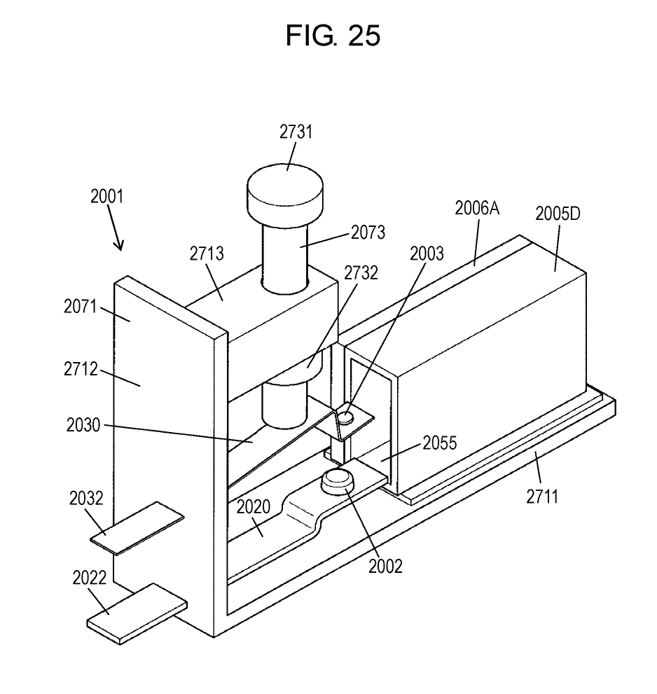

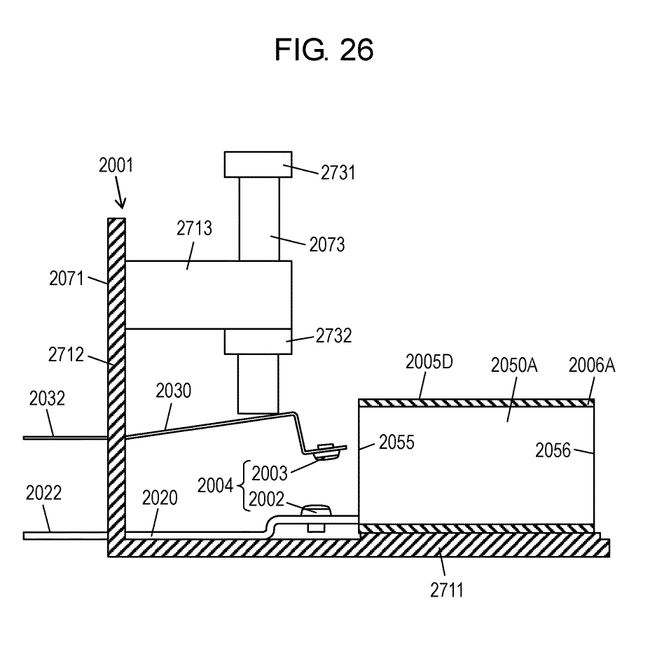

In contact device 2001 with the above-described configuration, arc-extinguishing frame 2005 is provided around contact unit 2004, but contact unit 2004 may be provided outside of arc-extinguishing frame 2005. As illustrated in FIGS. 25 and 26, arc-extinguishing frame 2005D is formed in a rectangular parallelepiped shape whose longitudinal direction is in the left-right direction, including flow path 2050A formed in the left-right direction to communicate with the space including contact unit 2004. Arc-extinguishing frame 2005D includes opening 2055 in a left surface and ventilation hole 2056 on a right surface. Arc-extinguishing frame 2005D is disposed on the right side of contact unit 2004 so that contact unit 2004 is positioned outside of arc-extinguishing frame 2005D. Magnet 2006A has a thickness in the front-rear direction, and is disposed on the rear side of arc-extinguishing frame 2005D to generate a magnetic field toward the rear direction in the space including contact unit 2004 and a space in arc-extinguishing frame 2005D.

When current flows from movable contact 2003 toward fixed contact 2002, an arc is extended toward the right direction and taken into arc-extinguishing frame 2005D through opening 2055. Since arc-extinguishing frame 2005D includes ventilation hole 2056 in the right surface, air in arc-extinguishing frame 2005D expanded by heat of the arc is ejected through ventilation hole 2056. This facilitates the extension of the arc to extinguish the arc fast.

### Fourth Exemplary Embodiment

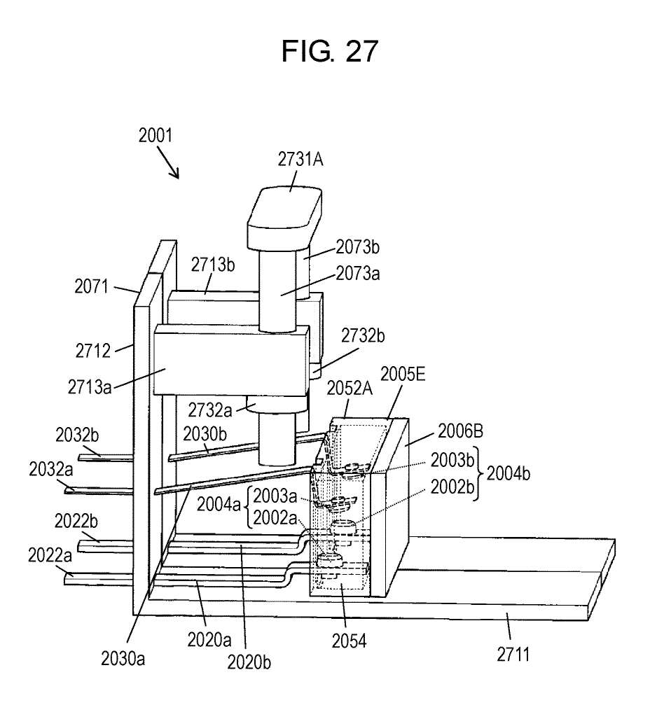

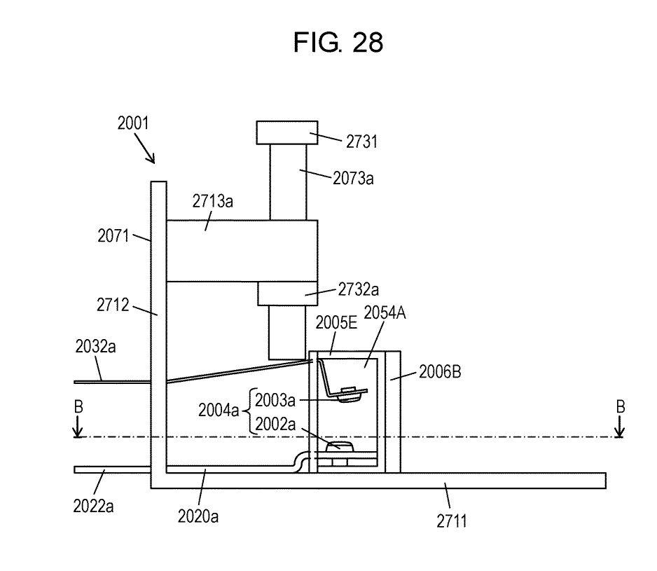

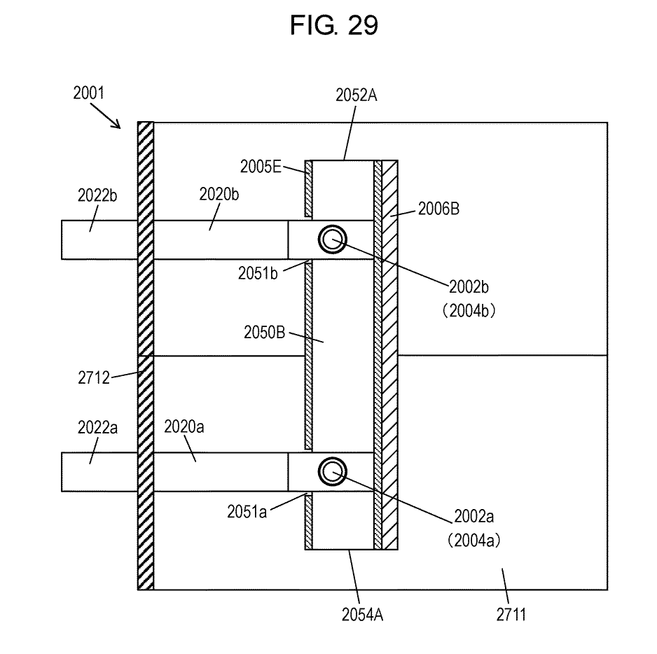

Contact device 2001 according to the third exemplary embodiment includes one contact unit 2004, whereas contact device 2001 according to the present exemplary embodiment includes two contact units 2004. Any identical component as in the third exemplary embodiment is denoted by an identical reference numeral, and description thereof is omitted. FIG. 27 illustrates an external perspective view of contact device 2001 according to the present exemplary embodiment, and FIG. 28 illustrates a front view of contact device 2001. FIG. 29 illustrates a sectional view taken along line B-B in FIG. 28. In the present exemplary embodiment, illustration of cover 2072 is omitted.

Contact device 2001 according to the present exemplary embodiment includes two sets of contact unit 2004 (fixed contact 2002, movable contact 2003), fixed contact plate 2020, movable contact plate 2030, movable shaft 2073, and holding part 2713. The sets of contact unit 2004 (fixed contact 2002, movable contact 2003), fixed contact plate 2020, movable contact plate 2030, movable shaft 2073, and holding part 2713 are provided side by side in the front-rear direction. In order to distinguish the two sets of contact unit 2004 (fixed contact 2002, movable contact 2003), fixed contact plate 2020, movable contact plate 2030, movable shaft 2073, and holding part 2713 in the following description, components of the set on the front side are denoted by reference numerals followed by “a”, and components of the set on the rear side are denoted by reference numerals followed by “b”.

In contact device 2001 according to the present exemplary embodiment, upper ends of movable shaft 2073a and movable shaft 2073b are coupled with each other through first flange part 2731A so as to simultaneously close or open two contact units 2004a and 2004b.

Arc-extinguishing frame 2005E according to the present exemplary embodiment is provided around two contact units 2004a and 2004b, and includes flow path 2050B formed in the front-rear direction. Hole 2051a for housing contact unit 2004a in arc-extinguishing frame 2005E and hole 2051b for housing contact unit 2004b in arc-extinguishing frame 2005E are formed in a left sidewall of arc-extinguishing frame 2005E. Arc-extinguishing frame 2005E includes ventilation hole 2052A in a rear surface and ventilation hole 2054A in a front surface.

Magnet 2006B applies a magnetic field toward the left direction to a space including contact units 2004a and 2004b in arc-extinguishing frame 2005E.

As described above, contact device 2001 according to the present exemplary embodiment includes a plurality of contact units 2004 sharing, for example, arc-extinguishing frame 2005E and magnet 2006B, and thus the present exemplary embodiment can achieve space saving and reduction in cost as compared to a case in which a plurality of contact devices 2001 each including one contact unit 2004 are used.

Arc-extinguishing frame 2005E includes the openings (ventilation hole 2052A, ventilation hole 2054A) in the front surface and the rear surface. Thus, even when current flows in directions different from each other between two contact units 2004, air expanded by heat of an arc can be ejected through ventilation hole 2052A or 2054A to extinguish the arc fast.

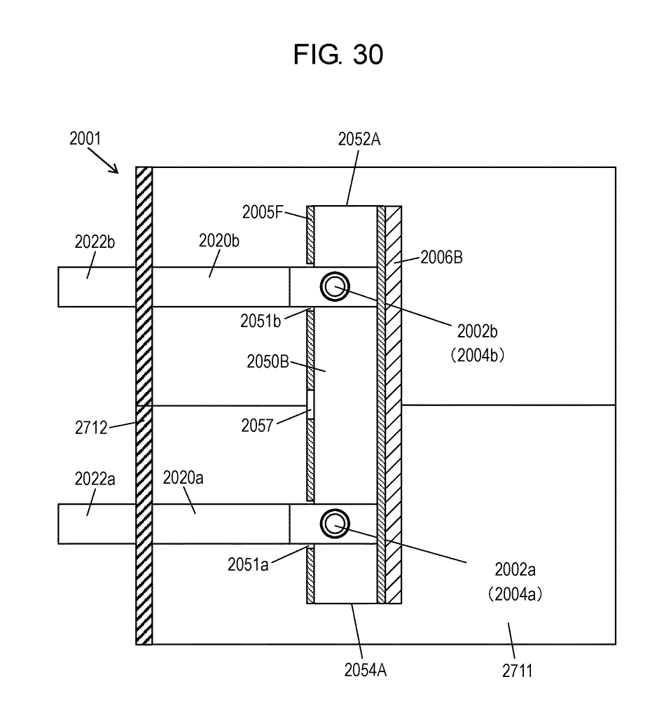

Arc-extinguishing frame 2005E may include a hole (air intake and ejecting hole) in each surface between a plurality of contact units 2004 in the front-rear direction. As illustrated in FIG. 30, arc-extinguishing frame 2005F includes air intake and ejecting hole 2057 formed in a left sidewall between contact units 2004a and 2004b in the front-rear direction. This air intake and ejecting hole 2057 allows efficient ejection of air out of arc-extinguishing frame 2005F or efficient intake of air into arc-extinguishing frame 2005F.

For example, when current flows from movable contact 2003a toward fixed contact 2002a and current flows from movable contact 2003b toward fixed contact 2002b, arcs generated at contact units 2004a and 2004b are extended toward the rear direction. In this case, air mainly expanded by heat of an arc generated at contact unit 2004a between contact units 2004a and 2004b is ejected through air intake and ejecting hole 2057. In other words, air intake and ejecting hole 2057 leads to an improved ejection efficiency from arc-extinguishing frame 2005F, thereby facilitating the extension of the arc generated at contact unit 2004a to extinguish the arc fast.

When current flows from movable contact 2003a toward fixed contact 2002a and current flows from fixed contact 2002b toward movable contact 2003b, an arc generated at contact unit 2004a is extended toward the rear direction, and an arc generated at contact unit 2004b is extended toward the front direction. In this case, air expanded by heat of the arcs generated at contact units 2004a and 2004b between contact units 2004a and 2004b is ejected through air intake and ejecting hole 2057. In other words, air intake and ejecting hole 2057 leads to an improved ejection efficiency from arc-extinguishing frame 2005F, thereby facilitating the extension of the arcs generated at contact units 2004a and 2004b to extinguish the arc fast.

When current flows from fixed contact 2002a toward movable contact 2003a and current flows from movable contact 2003b toward fixed contact 2002b, an arc generated at contact unit 2004a is extended toward the front direction, and an arc generated at contact unit 2004b is extended toward the rear direction. In this case, when the arcs are generated at contact units 2004a and 2004b and air is ejected through ventilation holes 2052A and 2054A, air is taken into arc-extinguishing frame 2005F through air intake and ejecting hole 2057. In other words, air intake and ejecting hole 2057 leads to an improved intake efficiency into arc-extinguishing frame 2005F, thereby facilitating the extension of the arcs generated at contact units 2004a and 2004b to extinguish the arc fast.

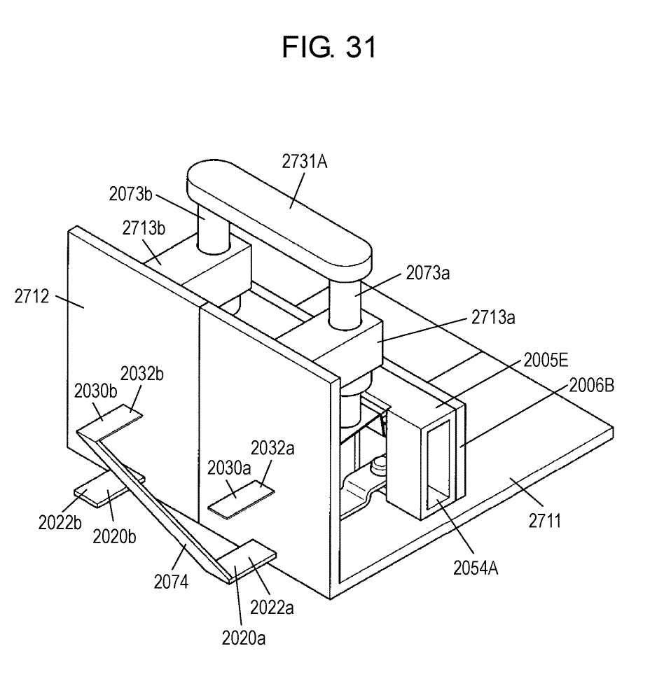

In contact device 2001, two contact units 2004a and 2004b may be serially connected with each other. As illustrated in FIG. 31, terminal part 2022a of fixed contact plate 2020a and terminal part 2032b of movable contact plate 2030b are short-circuited using conducting member 2074, so that contact units 2004a and 2004b are serially connected with each other. Although conducting member 2074 is provided while being exposed from side plate 2712, side plate 2712 may be formed by insert molding of conducting member 2074.

The serial connection of two contact units 2004a and 2004b leads to division of voltage applied between fixed contact 2002 and movable contact 2003 at contact opening as compared to the configuration including only one contact unit 2004, thereby achieving an improved voltage resistance of contact device 2001.

With the above-described configuration, a direction of a force (Lorentz force) acting on a current flowing between fixed contact 2002 and movable contact 2003 due to an applied magnetic field is identical between a plurality (two) of contact units 2004a and 2004b. In other words, the directions of currents flowing through contact units 2004a and 2004b are identical to each other, and thus arcs generated at contact units 2004a and 2004b can be extended in the same direction. Thus, air expanded by heat of the arcs generated at contact units 2004a and 2004b is ejected through one of ventilation holes 2052A and 2054A, and air is taken into arc-extinguishing frame 2005E through the other of ventilation holes 2052A and 2054A. Accordingly, air flows only in one direction through flow path 2050B of arc-extinguishing frame 2005E, so that the intake and ejection of air can be efficiently performed, thereby facilitating the extension of the arc to extinguish the arc faster. In addition, arcs generated at contact units 2004a and 2004b are extended in the same direction, thereby preventing contact between the arcs.

In contact device 2001, two contact units 2004a and 2004b may be connected with each other in parallel. Contact units 2004a and 2004b are connected with each other in parallel by short-circuiting terminal part 2022a of fixed contact plate 2020a and terminal part 2022b of fixed contact plate 2020b, and also short-circuiting terminal part 2032a of movable contact plate 2030a and terminal part 2032b of movable contact plate 2030b.

The parallel connection of two contact units 2004a and 2004b leads to division of current flowing between fixed contact 2002 and movable contact 2003 at contact closing as compared to the configuration including only one contact unit 2004, thereby achieving an improved current capacity of contact device 2001.

In addition, the directions of currents flowing through contact units 2004a and 2004b are identical to each other, and thus arcs generated at contact units 2004a and 2004b can be extended in the same direction. This facilitates the extension of the arc to extinguish the arc faster. In addition, contact between the arcs can be prevented.

Although one magnet 2006B is used to apply a magnetic field on contact units 2004a and 2004b in one direction in the above-described configuration, two magnets may be used to apply magnetic fields on respective contact units 2004a and 2004b. This allows the magnetic fields applied to respective contact units 2004a and 2004b to have directions different from each other, and thus arcs generated at contact units 2004a and 2004b can be extended in the same direction even when current flows in directions different between contact units 2004a and 2004b.

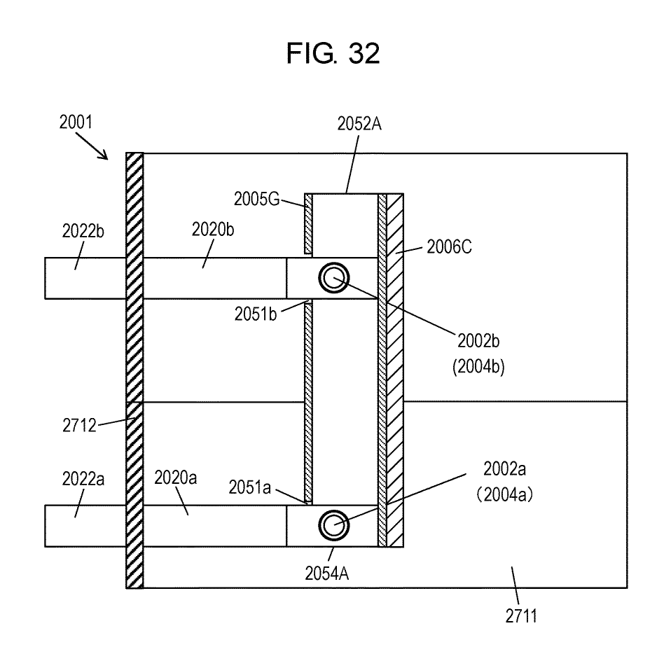

When the direction of the current flowing between fixed contact 2002 and movable contact 2003 is set to a specific direction, a direction in which an arc is extended is also specified, and thus part of arc-extinguishing frame 2005E can be omitted. For example, when the direction of the current is set to a direction from movable contact 2003 toward fixed contact 2002, an arc is extended toward the rear direction. In this case, no arc exists on the front side of contact unit 2004a, and thus arc-extinguishing frame 2005G having an asymmetric shape in the front-rear direction as illustrated in FIG. 32 can be used. Thus, an arc-extinguishing space formed by arc-extinguishing frame 2005G is asymmetric with respect to contact unit 2004b. A sidewall of arc-extinguishing frame 2005G on the front side of contact unit 2004b is omitted, and hole 2051a through which fixed contact plate 2020a and movable contact plate 2030a are disposed is formed continuously with ventilation hole 2054A. Accordingly, arc-extinguishing frame 2005G can have a shorter dimension in the front-rear direction than that of arc-extinguishing frame 2005E. Magnet 2006C can have a shorter dimension in the front-rear direction than that of magnet 2006B. This can achieve reduction in materials of arc-extinguishing frame 2005G and magnet 2006C, and also reduction in cost. In addition, contact device 2001 can have a smaller size, specifically, a shorter width in the front-rear direction, and thus contact device 2001 can be thinned.

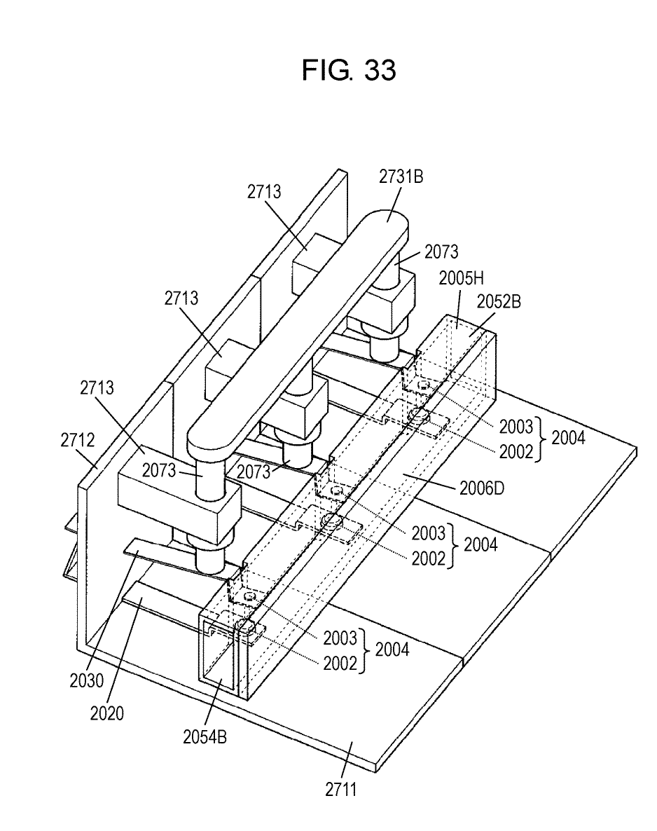

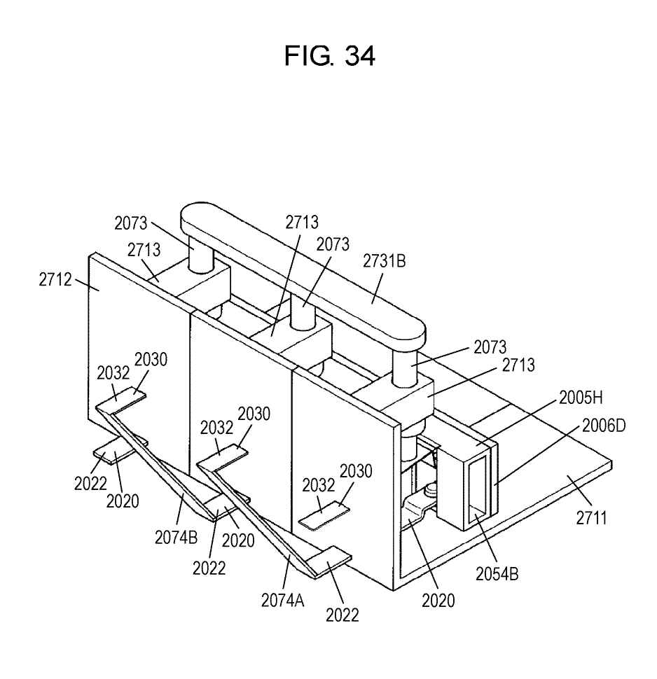

The number of contact units 2004 is not limited to two, but contact device 2001 may include a larger number of contact units 2004. As illustrated in FIGS. 33 and 34, contact device 2001 includes three contact units 2004. This contact device 2001 includes arc-extinguishing frame 200511 provided around three contact units 2004, and magnet 2006D configured to apply a magnetic field in arc-extinguishing frame 200511. Terminal part 2022 of fixed contact plate 2020 on the front side and terminal part 2032 of movable contact plate 2030 in a central part are short-circuited through conducting member 2074A, and terminal part 2022 of fixed contact plate 2020 in the central part and terminal part 2032 of movable contact plate 2030 on the rear side are short-circuited through conducting member 2074B. Accordingly, three contact units 2004 are serially connected with each other, and an arc generated at each contact unit 2004 is extended in an identical direction. Arc-extinguishing frame 2005, which includes openings (ventilation hole 2052B, ventilation hole 2054B) in the front surface and the rear surface, can extinguish the arc fast irrespective of the direction of the current flowing between fixed contact 2002 and movable contact 2003.

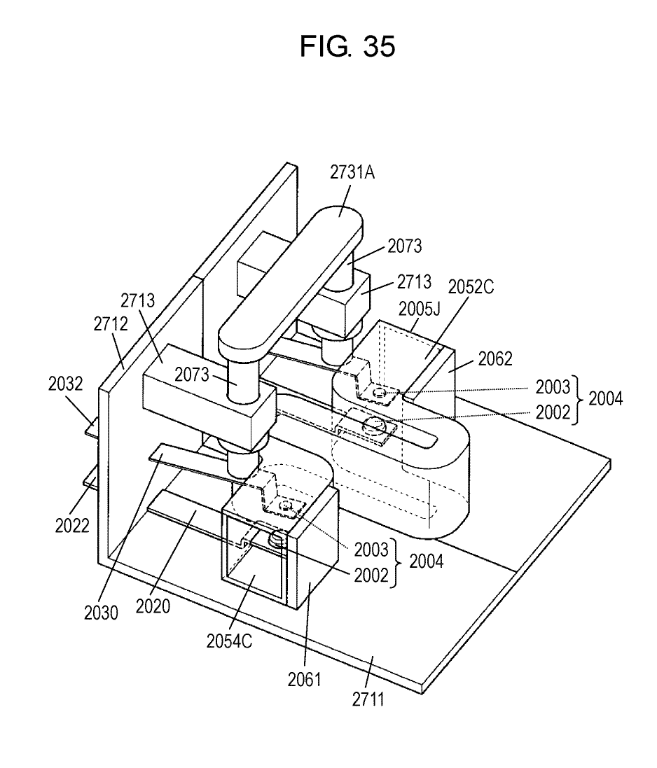

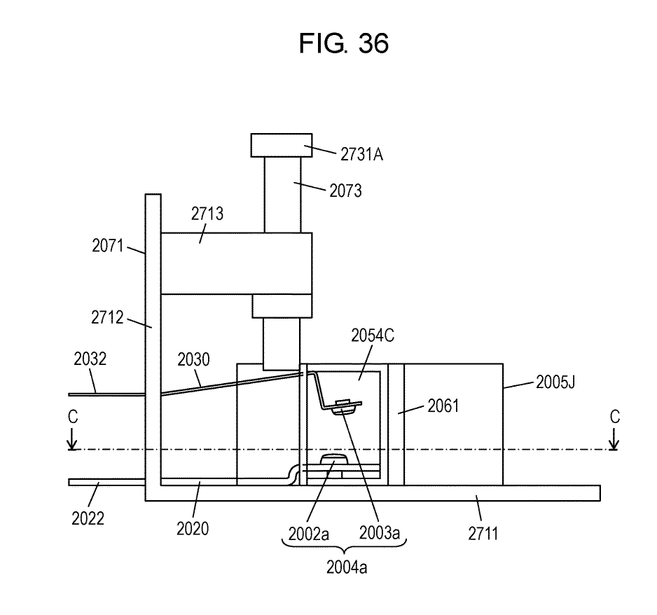

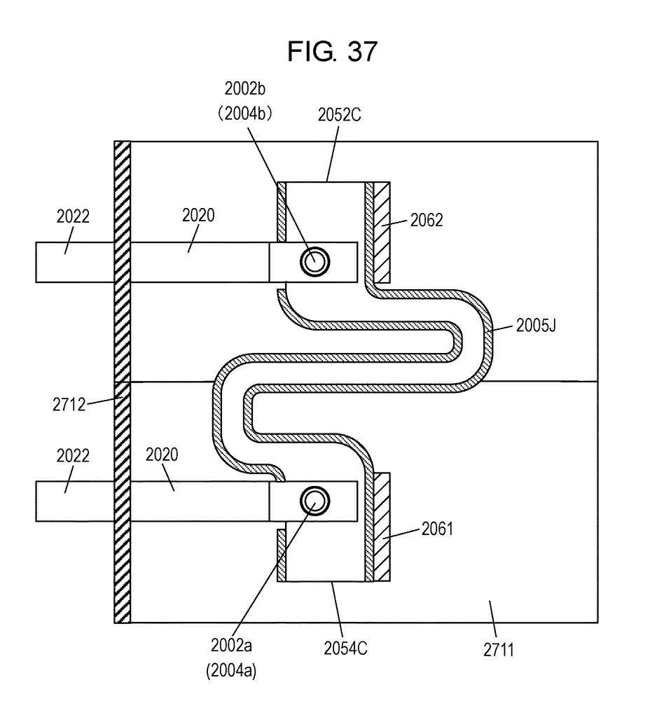

The shape of arc-extinguishing frame 2005E is not limited to a rectangular parallelepiped shape, but may be any shape that forms a flow path communicating with at least one side in the front-rear direction with respect to the space including contact unit 2004. For example, as illustrated in FIGS. 35 to 37, arc-extinguishing frame 2005J is formed in an S shape in which a part between contact units 2004a and 2004b is curved, and a space including contact unit 2004a and a space including contact unit 2004b are continuously formed. FIG. 37 is a sectional view taken along line C-C in FIG. 36.

Contact device 2001 according to the present modification includes two magnets 2061 and 2062, magnet 2061 applying a magnetic field to the space including contact unit 2004a, magnet 2062 applying a magnetic field to the space including contact unit 2004b. With this configuration including two magnets 2061 and 2062, arcs can be extended in directions different from each other even when current flows in an identical direction between contact units 2004a and 2004b. Accordingly, an arc generated at contact unit 2004a can be extended in the front direction, and an arc generated at contact unit 2004b can be extended in the rear direction. This allows air in arc-extinguishing frame 2005J to be efficiently ejected through ventilation holes 2052C and 2054C, thereby extinguishing the arc fast.

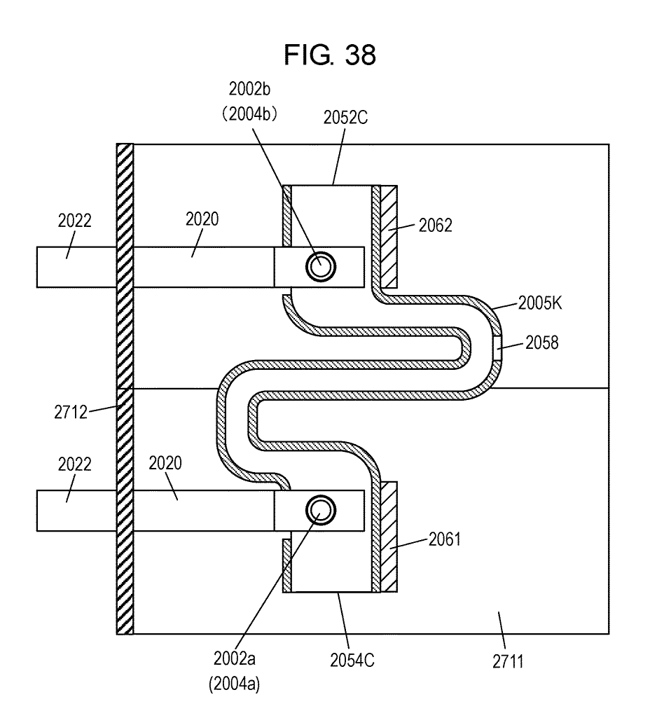

Arc-extinguishing frame 2005K in which hole 2058 is formed between contact units 2004a and 2004b as illustrated in FIG. 38 may be used. This arc-extinguishing frame 2005K, which includes hole 2058, allows more efficient ejection of air out of arc-extinguishing frame 2005K or more efficient intake of air into arc-extinguishing frame 2005K.

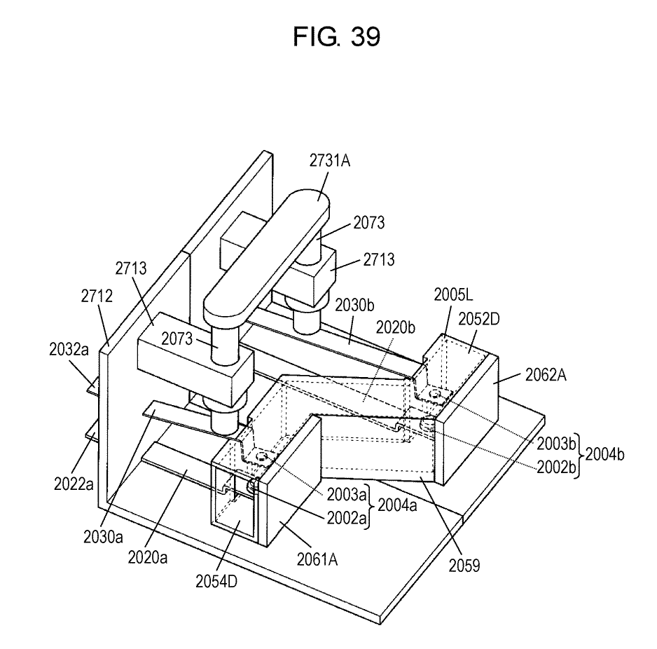

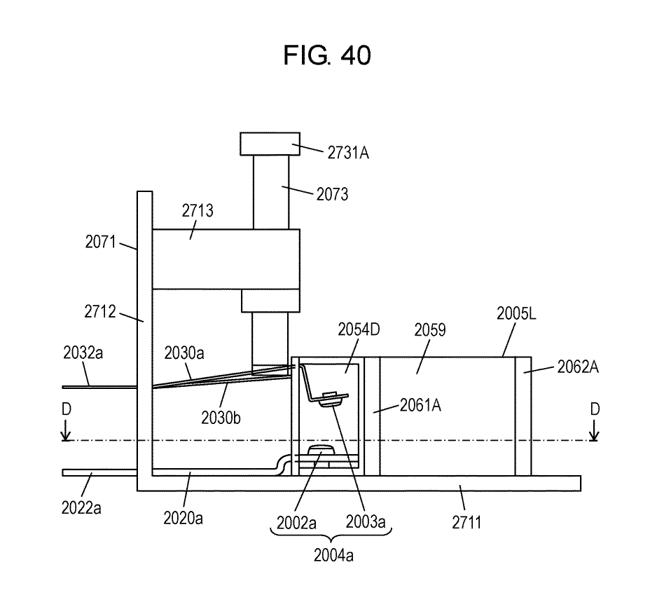

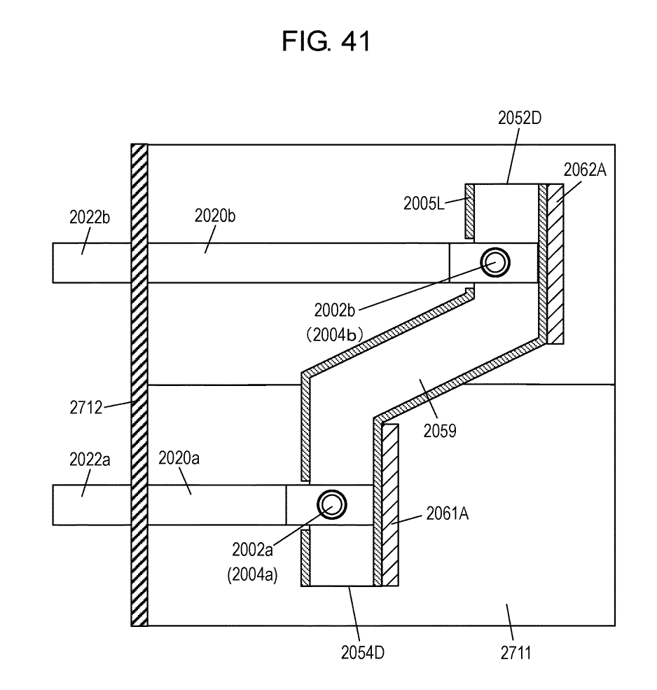

Positions of contact units 2004a and 2004b in the left-right direction may be different from each other. As illustrated in FIGS. 39 to 41, fixed contact plate 2020b and movable contact plate 2030b are formed longer than fixed contact plate 2020a and movable contact plate 2030a, and contact unit 2004b is positioned further on the right side than contact unit 2004a. FIG. 41 is a sectional view taken along line D-D in FIG. 40. Arc-extinguishing frame 2005L is formed around both of contact units 2004a and 2004b, including tilted part 2059 through which the space including contact unit 2004a and the space including contact unit 2004b are continuously formed. Contact device 2001 according to the present modification includes two magnets 2061A and 2062A, magnet 2061A applying a magnetic field to the space including contact unit 2004a, magnet 2062B applies a magnetic field to the space including contact unit 2004b. With this configuration including two magnets 2061A and 2062A, arcs can be extended in directions different from each other even when current flows in an identical direction between contact units 2004a and 2004b. Accordingly, an arc generated at contact unit 2004a can be extended in the front direction, and an arc generated at contact unit 2004b can be extended in the rear direction. This allows air in arc-extinguishing frame 2005L to be efficiently ejected through ventilation holes 2052D and 2054D, thereby extinguishing the arc fast.

### Fifth Exemplary Embodiment

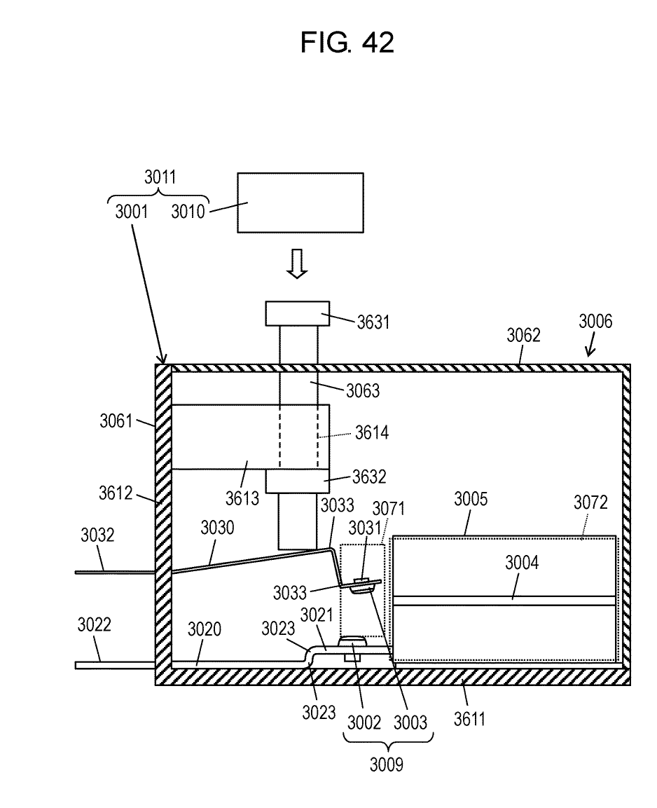

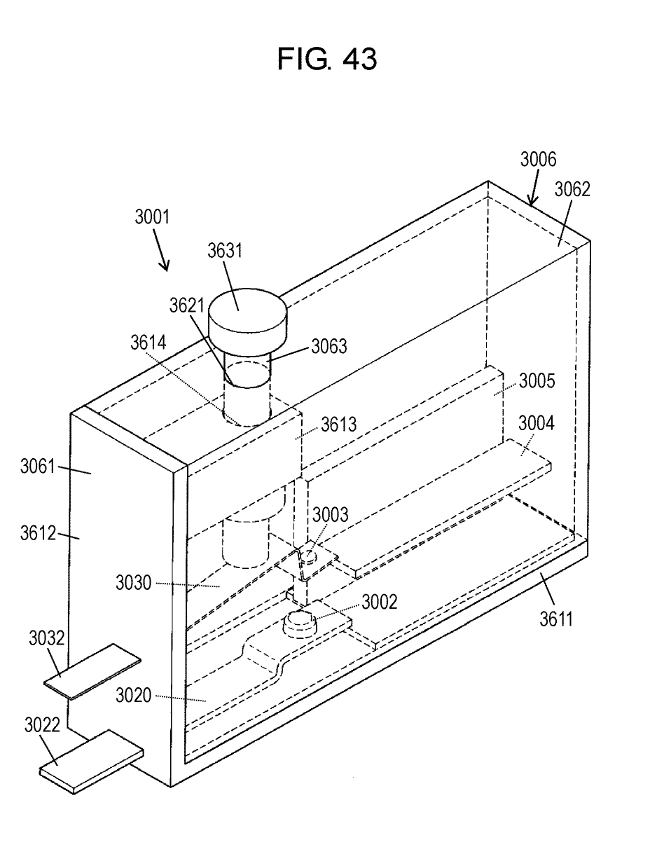

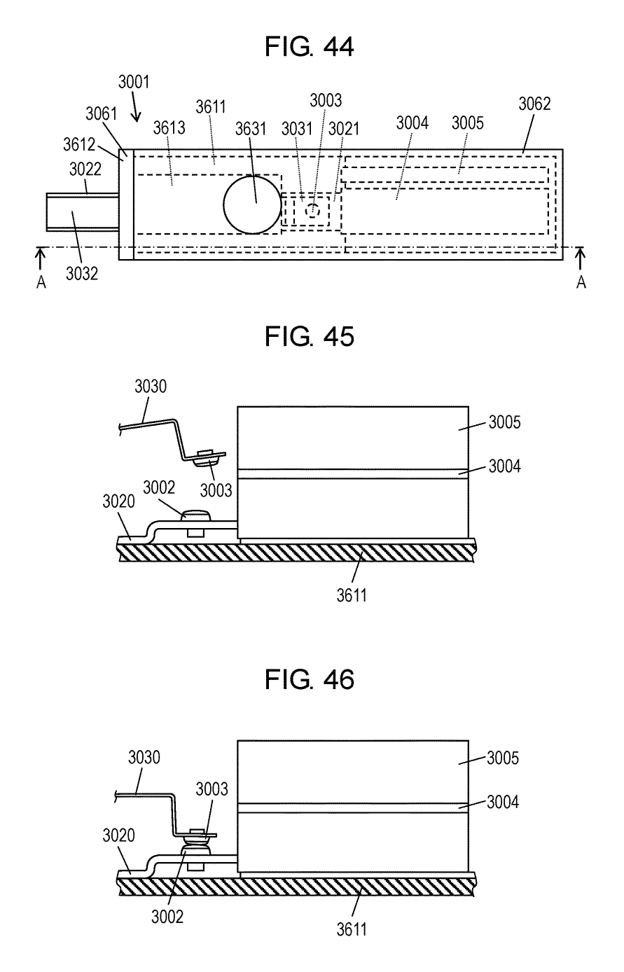

FIG. 43 illustrates an external perspective view of contact device 3001 according to the present exemplary embodiment, and FIG. 44 illustrates a plan view of contact device 3001. FIG. 42 illustrates a sectional view taken along line A-A in FIG. 44. As illustrated in FIGS. 42 to 44, contact device 3001 according to the present exemplary embodiment includes contact unit 3009 including fixed contact 3002 and movable contact 3003 configured to move between a closed position at which movable contact 3003 is in contact with fixed contact 3002 and an open position at which movable contact 3003 is separate from fixed contact 3002, magnet 3005 configured to generate a magnetic field, and arc-extinguishing structure 3004 as an exemplary arc-extinguishing body.

The following describes a configuration of contact device 3001 according to the present exemplary embodiment in detail. Up-down and left-right directions in FIG. 42 are defined as up-down and left-right directions in the following description. The front-rear direction is defined to be a direction orthogonal to the up-down and left-right directions, and specifically, the front direction is defined to be a direction away from the drawing plane of FIG. 42 (the down direction in FIG. 44), and the rear direction is defined to be a direction toward the drawing plane (the up direction in FIG. 44).

The following describes an example in which electromagnetic relay 3011 includes contact device 3001 according to the present exemplary embodiment and electromagnetic device 3010 configured to move movable contact 3003 as illustrated in FIG. 42. Usage of contact device 3001 is not limited to electromagnetic relay 3011, and contact device 3001 may be used in, for example, a switch or a breaker (circuit breaker).

In contact device 3001 according to the present exemplary embodiment, contact unit 3009 (fixed contact 3002 and movable contact 3003), magnet 3005, and arc-extinguishing structure 3004 are housed in rectangular parallelepiped case 3006. Case 3006 includes body 3061 and cover 3062 attached to body 3061. Body 3061 is formed in an L shape with bottom plate 3611 and side plate 3612, serving as a bottom part and a left sidewall of case 3006. Cover 3062 is formed in a rectangular parallelepiped shape having a hollow structure with openings on a lower surface and a left surface, and is attached to body 3061 such that body 3061 covers the openings on the lower surface and the left surface. For simplicity of description of the configuration of contact device 3001, illustration of cover 3062 is omitted in drawings except for FIGS. 42 to 44.

Fixed contact 3002 is provided to rectangular fixed contact plate 3020 including contact holding part 3021, terminal part 3022, and curved parts 3023. Fixed contact plate 3020 is a metal plate whose longitudinal direction is in the left-right direction and thickness direction is in the up-down direction, and is provided along bottom plate 3611 of body 3061. Fixed contact plate 3020 is formed including two curved parts 3023 such that contact holding part 3021 on a right end side is separate from bottom plate 3611. Fixed contact 3002 is swaged on contact holding part 3021 so that fixed contact 3002 is fixed to an upper surface of contact holding part 3021. Fixed contact plate 3020 is provided penetrating side plate 3612, and terminal part 3022 protruding from side plate 3612 to a left side is electrically connected with, for example, a power source (not illustrated). In the present exemplary embodiment, fixed contact plate 3020 and fixed contact 3002 are separately provided, but fixed contact plate 3020 and fixed contact 3002 may be integrally provided by, for example, forming fixed contact 3002 through embossing of fixed contact plate 3020.

Movable contact 3003 is provided to rectangular movable contact plate 3030 including contact holding part 3031, terminal part 3032, and curved parts 3033. Movable contact plate 3030 is a metal plate whose longitudinal direction is in the left-right direction and thickness direction is in the up-down direction, and is fixed to side plate 3612 such that a lower surface faces an upper surface of fixed contact plate 3020. Movable contact plate 3030 is formed including two curved parts 3033 such that contact holding part 3031 on a right end side is close to bottom plate 3611. Movable contact 3003 is swaged on contact holding part 3031 so that movable contact 3003 is fixed on a lower surface of contact holding part 3031 at a position facing fixed contact 3002 in the up-down direction. Movable contact plate 3030 is provided penetrating side plate 3612, and terminal part 3032 protruding from side plate 3612 to a left side is electrically connected with, for example, a load (not illustrated). Movable contact plate 3030 is also used as a plate spring having elasticity in the up-down direction, and the elasticity of movable contact plate 3030 is used for contact closing at which movable contact 3003 and fixed contact 3002 are in contact with each other, and for contact opening at which movable contact 3003 and fixed contact 3002 are separate from each other. In the present exemplary embodiment, movable contact plate 3030 and movable contact 3003 are separately provided, but may be integrally provided by, for example, forming movable contact 3003 through embossing of movable contact plate 3030.

Movable contact plate 3030 is bent by round movable shaft 3063 in the down direction, so that contact holding part 3031 and movable contact 3003 move in the down direction. Movable shaft 3063 is movably held in the up-down direction by holding part 3613 provided protruding from side plate 3612 of case 3006 to a right side, and a lower end of movable shaft 3063 is in contact with an upper surface of movable contact plate 3030.

Holding part 3613 is formed in a rectangular parallelepiped shape and provided at a position above movable contact plate 3030 on side plate 3612. Holding part 3613 is provided with hole 3614 penetrating in the up-down direction, through which movable shaft 3063 is movably held in the up-down direction. Hole 3621 penetrating in the up-down direction is also formed in an upper surface of cover 3062, and movable shaft 3063 is provided such that movable shaft 3063 penetrates hole 3621 of cover 3062. In other words, movable shaft 3063 is held while protruding from case 3006.

First flange part 3631 is formed at an upper end of movable shaft 3063, and a lowest position of movable shaft 3063 is a position at which a lower surface of first flange part 3631 is in contact with the upper surface of cover 3062. In addition, second flange part 3632 of movable shaft 3063 is formed at a position below holding part 3613, and a highest position of movable shaft 3063 is a position at which an upper surface of second flange part 3632 is in contact with a lower surface of holding part 3613.

Movable shaft 3063 is moved in the down direction by electromagnetic device 3010 (refer to FIG. 42). Electromagnetic device 3010 has a conventionally known configuration in which, for example, an excitation coil and a movable iron core not illustrated are included, and the movable iron core configured to be moved in the down direction through magnetic flux generated by the excitation coil when energized is coupled with movable shaft 3063. Thus, when the excitation coil is energized to move the movable iron core in the down direction, movable shaft 3063 is provided with force in the down direction, and is moved in the down direction. The configuration of electromagnetic device 3010 is not limited to the above-described configuration.

The following describes movement of movable contact 3003 with reference to FIGS. 45 to 47. When the excitation coil is not energized, no force in the down direction is applied to movable shaft 3063, whereby movable contact 3003 is positioned separate from fixed contact 3002 as illustrated in FIG. 45, and fixed contact plate 3020 and movable contact plate 3030 are electrically broken.

When the excitation coil is energized to move movable shaft 3063 in the down direction, movable contact plate 3030 is bent in the down direction so that contact holding part 3031 and movable contact 3003 move in the down direction. Accordingly, as illustrated in FIG. 46, movable contact 3003 is in contact with fixed contact 3002, so that movable contact plate 3030 and fixed contact plate 3020 have conduction therebetween. The closed position is the position of movable contact 3003 when movable contact 3003 and fixed contact 3002 are in contact with each other.

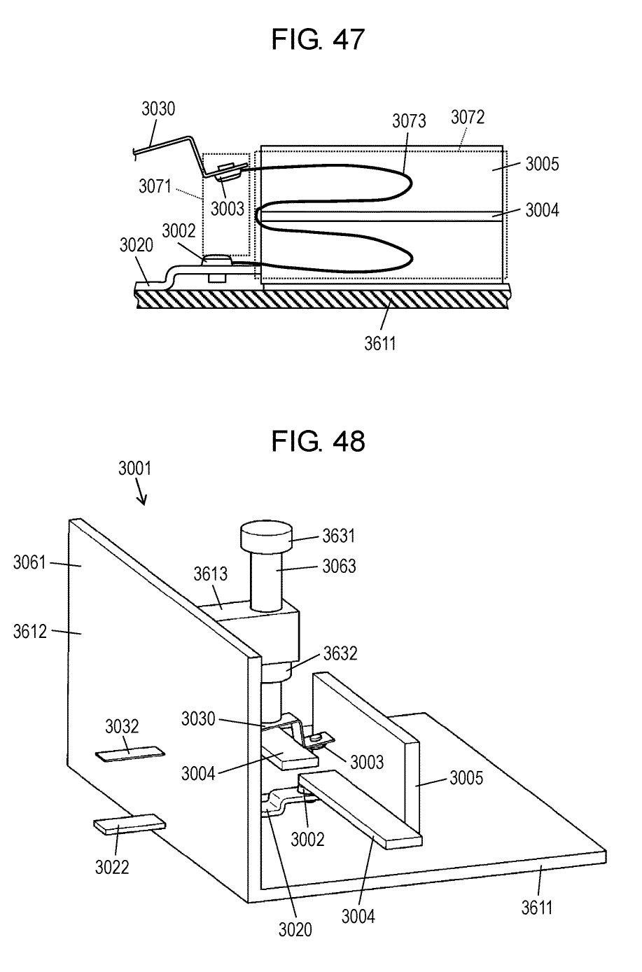

Since movable contact plate 3030 has elasticity in the up-down direction, an upward force due to a restoring force for returning movable contact plate 1030 from the bent state to the original state acts to separate movable contact 3003 from fixed contact 3002. When the energization of the excitation coil is stopped and the downward force on movable shaft 3063 is canceled, the restoring force of movable contact plate 3030 moves contact holding part 3021 in the up direction, so that movable contact 3003 separates from fixed contact 3002. In this movement, due to the restoring force of movable contact plate 3030, movable contact 3003 is temporarily overshot to a position higher than a steady position (refer to FIG. 45) at contact opening as illustrated in FIG. 47. In the present exemplary embodiment, the open position is the position to which movable contact 3003 is overshoot. In other words, movable contact 3003 moves in the up-down direction in movable region 3071 having a lower limit at the closed position and an upper limit at the open position.

Magnet 3005 is formed in a plate shape whose thickness direction is in the front-rear direction, generating a magnetic field in a space including movable region 3071 of movable contact 3003 and a space on the right side of movable region 3071 (hereinafter the space on the right side is referred to as arc-extinguishing space 3072) in case 3006. In the present exemplary embodiment, magnet 3005 is disposed so as to generate magnetic fields toward the front direction in movable region 3071 and arc-extinguishing space 3072. FIGS. 42 and 47 schematically illustrate movable region 3071 and arc-extinguishing space 3072.

Arc-extinguishing structure 3004 is formed in a plate shape whose longitudinal direction is in the left-right direction and thickness direction is in the up-down direction, and is disposed in arc-extinguishing space 3072. Arc-extinguishing structure 3004 according to the present exemplary embodiment is made of only an insulator (for example, resin or ceramic) having an electric insulation property.

The following describes extinguishment of arc 3073 by magnet 3005 and arc-extinguishing structure 3004 with reference to FIG. 47. In the following description, current flows from fixed contact 3002 toward movable contact 3003.

When arc 3073 is generated between fixed contact 3002 and movable contact 3003 at contact opening, a Lorentz force toward the right direction acts on this arc 3073 due to a magnetic field toward the front direction. Arc 3073 is extended toward the right direction by this Lorentz force and taken into arc-extinguishing space 3072.

In the present exemplary embodiment, arc-extinguishing structure 3004 having an electric insulation property is provided in arc-extinguishing space 3072, and thus arc 3073 bypasses arc-extinguishing structure 3004. Accordingly, as illustrated in FIG. 47, bypassing arc-extinguishing structure 3004, arc 3073 is extended to protrude toward the right direction on the upside and downside of arc-extinguishing structure 3004.

As described above, contact device 3001 according to the present exemplary embodiment includes contact unit 3009 including fixed contact 3002 and movable contact 3003, magnet 3005 configured to generate a magnetic field, and arc-extinguishing structure 3004 (arc-extinguishing body). Movable contact 3003 moves between the closed position at which movable contact 3003 is in contact with fixed contact 3002 and the open position at which movable contact 3003 is separate from fixed contact 3002. The direction of action (the right direction) is a direction intersecting with a direction of the magnetic field applied to contact unit 3009 (the front direction) and with a direction in which movable contact 1003 moves (the up-down direction). Arc-extinguishing structure 3004 (arc-extinguishing body) forms an arc-extinguishing space in the direction of action.

Contact device 1001 according to the present exemplary embodiment, which has the above-described configuration, can easily extend an arc to extinguish the arc faster.

Contact device 3001 according to the present exemplary embodiment further includes the following configuration. The arc-extinguishing body includes first arc-extinguishing structure 3004, and movable contact 3003 moves in movable region 3071 between the closed position at which movable contact 3003 is in contact with fixed contact 3002 and the open position at which movable contact 3003 is separate from fixed contact 3002. Arc-extinguishing structure 3004 includes an insulator having an electric insulation property. When the direction of action (the left-right direction) is a direction intersecting with a direction of a magnetic field in movable region 3071 (the front direction) and with a direction in which movable contact 3003 moves (the up-down direction), arc-extinguishing structure 3004 is provided on at least one side (right side) of movable region 3071 in the direction of action (the left-right direction).

In contact device 3001 according to the present exemplary embodiment, which includes the above-described configuration, arc 3073 is extended to bypass arc-extinguishing structure 3004. Accordingly, arc 3073 is longer by a length corresponding to the bypassing of arc-extinguishing structure 3004 than in a case in which arc-extinguishing structure 3004 is not included, and thus can be extinguished fast. The fast extinguishment of arc 3073 enables a fast electric break between fixed contact 3002 and movable contact 3003 at contact opening, thereby achieving improved breaking performance of contact device 3001.

A direction of a current flowing between fixed contact 3002 and movable contact 3003 and a direction of a magnetic field in movable region 3071 and arc-extinguishing space 3072 are not limited to those described above. For example, in order to flow current from movable contact 3003 toward fixed contact 3002, magnet 3005 is disposed such that a magnetic field toward the rear direction is generated in movable region 3071 and arc-extinguishing space 3072. Accordingly, arc 3073 can be extended toward a direction in which arc-extinguishing structure 3004 is provided. In addition, arc 3073 can be extended in a direction departing from movable contact plate 3030 and fixed contact plate 3020, and can be prevented from contacting movable contact plate 3030 and fixed contact plate 3020.

A left end of arc-extinguishing structure 3004 is preferably disposed at a position closer to movable region 3071 so as to have a longer length of arc 3073. In addition, arc-extinguishing structure 3004 is preferably disposed at the same position in the up-down direction as a position of a central part of movable region 3071 in the up-down direction. When arc-extinguishing structure 3004 is disposed at such a position, arc 3073 bypasses arc-extinguishing structure 3004 in a longer distance, and thus can be extinguished faster.

Since arc-extinguishing structure 3004 according to the present exemplary embodiment is made of only an insulator having an electric insulation property, no current flows in arc-extinguishing structure 3004. Accordingly, arc 3073 is reliably extended to bypass arc-extinguishing structure 3004, thereby achieving improved arc-extinguishing performance of arc-extinguishing structure 3004. Although arc-extinguishing structure 3004 according to the present exemplary embodiment is made of an insulator only, any structure including an insulator is applicable, and arc-extinguishing structure 3004 may be made of, for example, metal doped with an insulator.

In addition, since arc-extinguishing structure 3004 is a plate, arc 3073 is more reliably extended to bypass arc-extinguishing structure 3004, thereby achieving further improved arc-extinguishing performance of arc-extinguishing structure 3004.

Contact device 3001 according to the present exemplary embodiment includes one magnet 3005, but may include a plurality of magnets 3005. For example, two magnets 3005 are disposed such that poles opposite to each other on the front and rear sides of arc-extinguishing structure 3004 have opposite polarities. This configuration leads to a strong magnetic field in movable region 3071 and arc-extinguishing space 3072, so that arc 3073 is extended longer to extinguish arc 3073 faster. In addition, a yoke (not illustrated) may be used to strengthen the magnetic field. For example, a yoke having a U shape is disposed around movable region 3071 and arc-extinguishing space 3072 to strengthen the magnetic field in movable region 3071 and arc-extinguishing space 3072, so that arc 3073 is extended longer to extinguish arc 3073 faster.

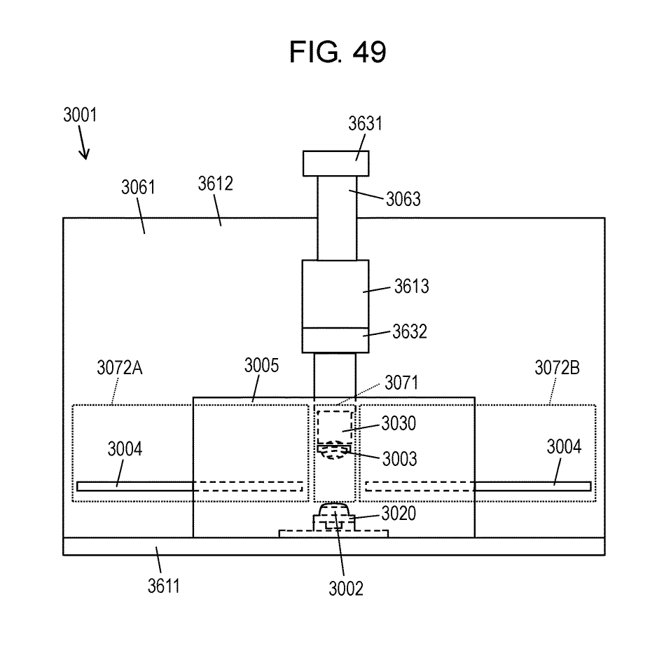

In contact device 3001, positions at which arc-extinguishing structure 3004 and magnet 3005 are provided are not limited to the above-described positions, and contact device 3001 may further include a plurality of arc-extinguishing structures 3004. FIGS. 48 and 49 illustrate a modification of contact device 3001 including two arc-extinguishing structures 3004. Arc-extinguishing structures 3004 are provided in a space on the front side (left side in FIG. 49) of movable region 3071 (arc-extinguishing space 3072A) and a space on the rear side (right side in FIG. 49) of movable region 3071 (arc-extinguishing space 3072B).

Magnet 3005 is provided on the right side of movable region 3071, has a thickness in the left-right direction, and applies a magnetic field toward the left direction in movable region 3071 and arc-extinguishing spaces 3072A, 3072B. When current flows from movable contact 3003 toward fixed contact 3002, an arc is extended toward the rear direction. When current flows from fixed contact 3002 toward movable contact 3003, an arc is extended toward the front direction. Accordingly, an arc is extended toward the front direction or the rear direction.

As described above, in the present modification, an arc is extended toward the front direction or the rear direction. Arc-extinguishing structures 3004 are provided on both sides of movable region 3071 in the front-rear direction (the direction of action). Accordingly, the arc is extended to bypass arc-extinguishing structure 3004 irrespective of a direction of a current flowing between movable contact 3003 and fixed contact 3002 and can be extinguished fast.

The arc is further extended toward the front-rear direction intersecting with the longitudinal directions of fixed contact plate 3020 and movable contact plate 3030 (the left-right direction). Thus, arc-extinguishing structures 3004 can be provided on both sides of movable region 3071 in the front-rear direction, and thus can be prevented from interfering with movable contact plate 3030 configured to move in the up-down direction.

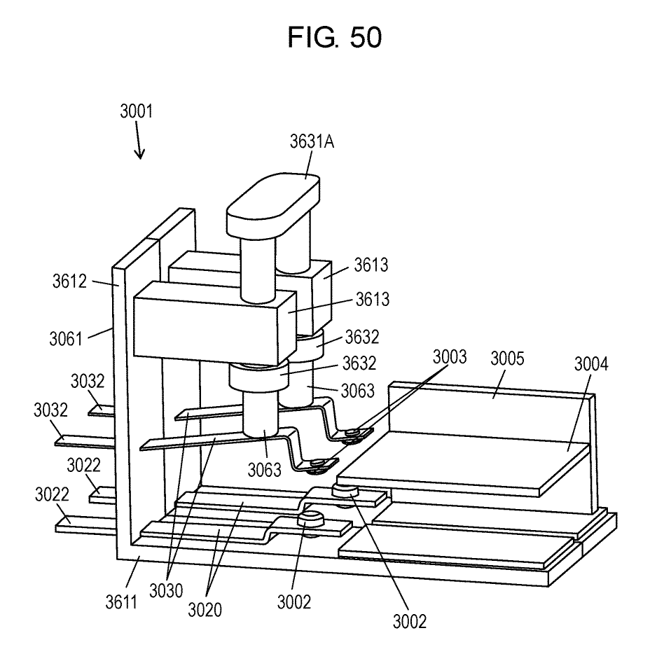

Contact device 3001 according to the present exemplary embodiment includes one set of fixed contact 3002 and movable contact 3003, but may include a plurality of sets of fixed contact 3002 and movable contact 3003. FIG. 50 illustrates a modification of contact device 3001 including two sets of fixed contact 3002, fixed contact plate 3020, movable contact 3003, movable contact plate 3030, movable shaft 3063, and holding part 3613. In contact device 3001 according to the present modification, the sets of fixed contact 3002, fixed contact plate 3020, movable contact 3003, movable contact plate 3030, movable shaft 3063, and holding part 3613 are provided side by side in the front-rear direction. Upper ends of two movable shafts 3063 are coupled with each other through first flange part 3631A so as to simultaneously close or open the two sets of fixed contact 3002 and movable contact 3003.

As illustrated in FIG. 50, when the plurality of sets of fixed contact 3002 and movable contact 3003 are included, arc-extinguishing structure 3004 and magnet 3005 can be shared by the plurality of sets of fixed contact 3002 and movable contact 3003. This achieves cost reduction and space saving as compared to a case in which a plurality of contact devices 3001 each including only one set of fixed contact 3002 and movable contact 3003 are used.

The sets of fixed contact 3002 and movable contact 3003 can be connected with each other in parallel by short-circuiting terminal parts 3022 of fixed contact plates 3020 and also short-circuiting terminal parts 3022 of movable contact plates 3030. This parallel connection leads to division of current flowing between fixed contact 3002 and movable contact 3003 at contact closing as compared to a configuration including one set of fixed contact 3002 and movable contact 3003, thereby achieving an improved current capacity of contact device 3001. The short circuit of fixed contact plates 3020 and the short circuit of movable contact plates 3030 may be achieved by, for example, a metal plate formed in side plate 3612 by insert molding.

The sets of fixed contact 3002 and movable contact 3003 may be serially connected with each other by short-circuiting terminal part 3022 of fixed contact plate 3020 in one of the sets and terminal part 3022 of movable contact plate 3030 in the other set. For example, the sets of fixed contact 3002 and movable contact 3003 can be serially connected with each other by short-circuiting terminal part 3022 of fixed contact plate 3020 on the front side and terminal part 3022 of movable contact plate 3030 on the rear side. This serial connection leads to division of voltage applied between fixed contact 3002 and movable contact 3003 at contact opening as compared to a configuration including one set of fixed contact 3002 and movable contact 3003, thereby achieving an improved voltage resistance of contact device 3001. With the above-described configuration, the direction of a current flowing between fixed contact 3002 and movable contact 3003 is identical for respective sets, and thus arc 3073 can be extended in the same direction and extinguished fast through one arc-extinguishing structure 3004.

When the sets of fixed contact 3002 and movable contact 3003 are connected in parallel or serially with each other as described above, a current flows in the same direction for respective sets, and thus arc 3073 can be extended in the same direction.

Two sets of fixed contact 3002 and movable contact 3003 may be connected with each other in different electrical power supply paths without short-circuiting terminal part 3022 of fixed contact plate 3020, and terminal part 3022 of movable contact plate 3030.

### Sixth Exemplary Embodiment

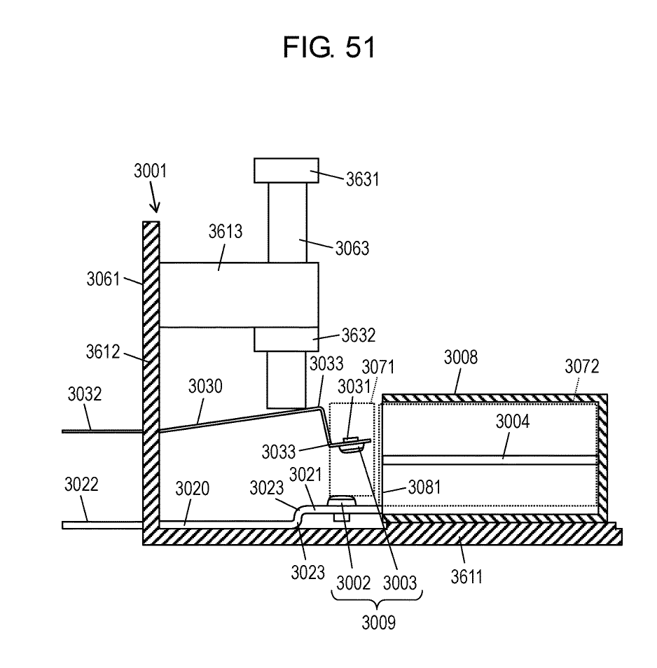

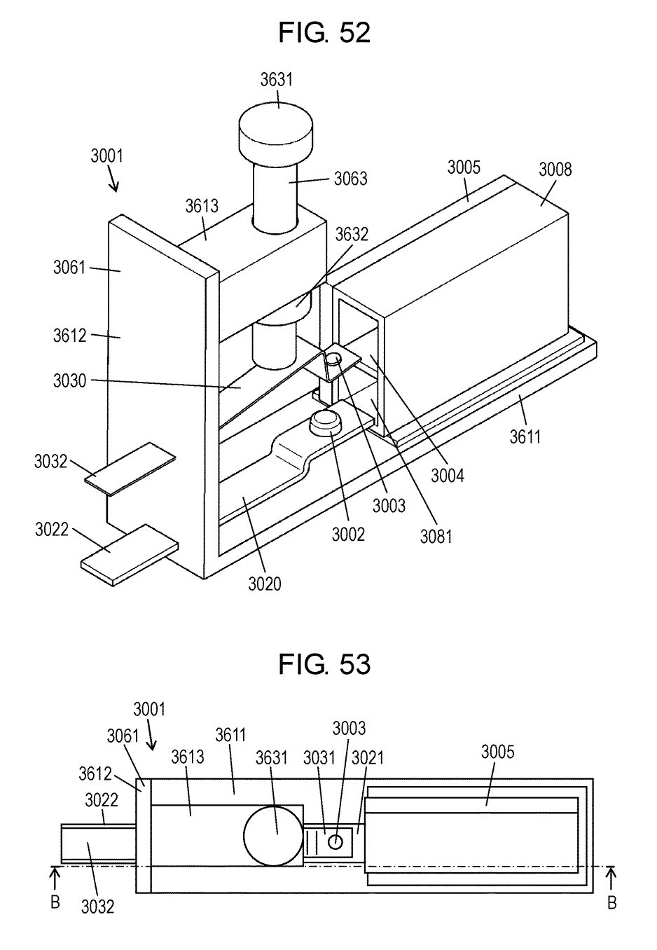

Contact device 3001 according to the present exemplary embodiment is different from contact device 3001 according to the fifth exemplary embodiment in that arc-extinguishing frame 3008 is further provided around arc-extinguishing space 3072 as illustrated in FIGS. 51 to 53. Any identical component as in the fifth exemplary embodiment is denoted by an identical reference numeral, and description thereof is omitted. FIG. 51 is a sectional view taken along line B-B in FIG. 53.

Arc-extinguishing frame 3008 is formed in a hollow rectangular parallelepiped shape and is made of, for example, material such as resin or ceramic having an electric insulation property. Arc-extinguishing frame 3008 is disposed on the upside of bottom plate 3611 of body 3061, includes opening 3081 in a left surface facing movable region 3071, and is disposed around arc-extinguishing space 3072 on the right side of movable region 3071. Arc-extinguishing structure 3004 is provided inside arc-extinguishing frame 3008.

Magnet 3005 is provided outside of arc-extinguishing frame 3008 (the rear side).

In contact device 3001 according to the present exemplary embodiment, which has the above-described configuration, when an arc is generated between fixed contact 3002 and movable contact 3003, the arc is extended to arc-extinguishing space 3072 in arc-extinguishing frame 3008 due to a magnetic field generated by magnet 3005. The arc has a high temperature and generates gas including metal in some cases. In the present exemplary embodiment, the arc is taken into arc-extinguishing frame 3008, which can prevent, for example, the metal included in the gas from being scattered and adhered onto fixed contact 3002 and movable contact 3003. Arc-extinguishing frame 3008 can prevent the arc from contacting, for example, magnet 3005 and case 3006.

The following describes modifications of contact device 3001. Any components according to the modifications of contact device 3001 are denoted by reference numerals followed by A, B, C . . . to distinguish the components.

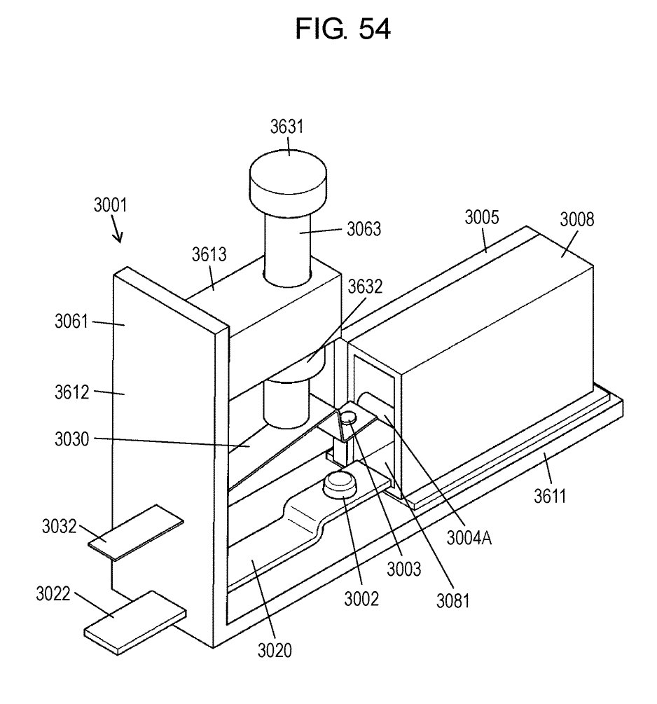

The shape of arc-extinguishing structure 3004 is not limited to a plate, but may be formed, for example, in a bar as illustrated in FIG. 54. Arc-extinguishing structure 3004A is formed in a round bar whose axial direction is in a direction of a magnetic field (the front direction) in arc-extinguishing space 3072. In other words, arc-extinguishing structure 3004A is disposed so as to intersect with an arc, and thus arc 3073 is extended to bypass arc-extinguishing structure 3004A. Similarly to the case of arc-extinguishing structure 3004 formed in a plate, the arc is extended to protrude toward the right direction on the upside and downside of arc-extinguishing structure 3004A, and can be extinguished fast. Material included in arc-extinguishing structure 3004A formed in a bar is reduced as compared to that of arc-extinguishing structure 3004 formed in a plate, thereby achieving cost reduction.

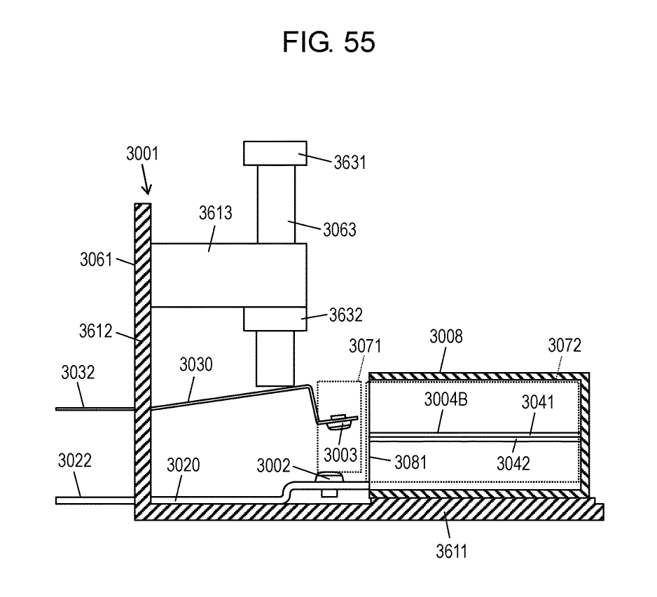

Arc-extinguishing structure 3004 may be a laminated body including a plurality of laminated layers made of materials different from each other. For example, as illustrated in FIG. 55, in arc-extinguishing structure 3004B, first layer 3041 made of an insulator having an electric insulation property (for example, resin or ceramic) and second layer 3042 made of a metal material are laminated in the up-down direction. Second layer 3042 made of a metal material has a strength higher than that of first layer 3041 made of an insulator. Thus, arc-extinguishing structure 3004B, which includes the laminated body in which first layer 3041 and second layer 3042 are laminated, can have an improved strength as compared to arc-extinguishing structure 3004 in which only insulators are laminated. Arc-extinguishing structure 3004B may have any structure including an insulator having an electric insulation property, and a layer made of metal doped with an insulator may be used in place of first layer 3041. Arc-extinguishing structure 3004B may be a metal plate coated by resin as an insulator, such as a metal plate formed in resin by insert molding.

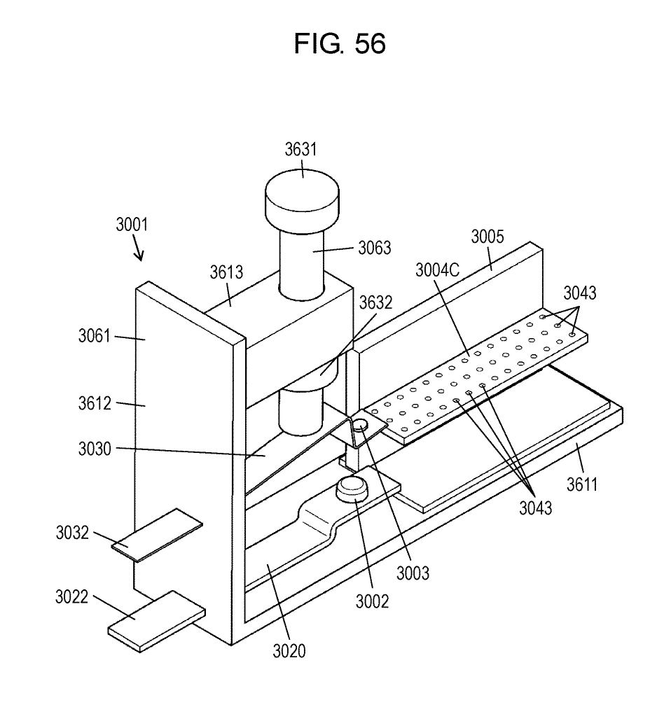

Arc-extinguishing structure 3004 may include one or a plurality of holes. For example, as illustrated in FIG. 56, arc-extinguishing structure 3004C includes a plurality of holes 3043 penetrating in the up-down direction. In FIG. 56, illustration of arc-extinguishing frame 3008 is omitted. Arc-extinguishing structure 3004C, which includes holes 3043, can have a reduced weight by the volume of holes 3043, thereby achieving reduction in weight of contact device 3001. In addition, material included in arc-extinguishing structure 3004C is reduced as compared to that of arc-extinguishing structure 3004, thereby achieving cost reduction. The shape of each hole 3043 formed in arc-extinguishing structure 3004C is not particularly limited. Arc-extinguishing structure 3004 may be formed in a mesh. As a modification of arc-extinguishing structure 3004C, one or a plurality of bottomed holes may be formed on a surface of arc-extinguishing structure 3004, which achieves the same effect as that of holes 3043.

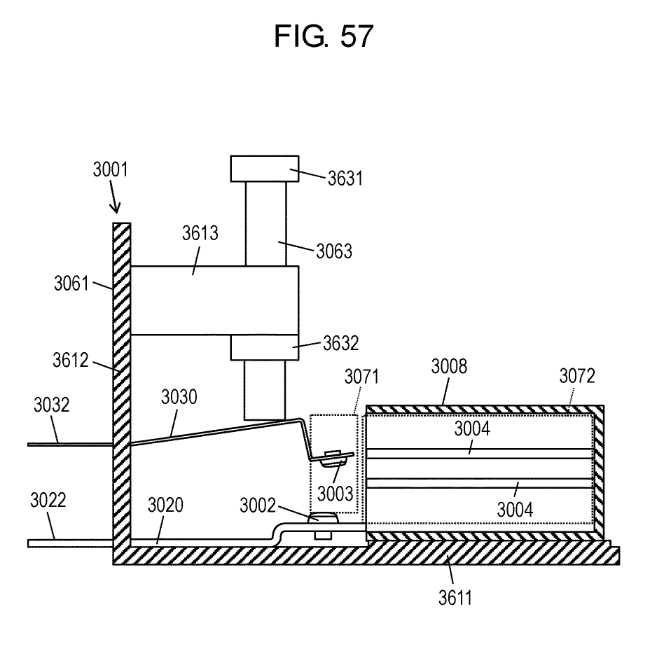

The number of arc-extinguishing structures 3004 is not limited to one, but a plurality of arc-extinguishing structures 3004 may be included. In an example illustrated in FIG. 57, contact device 3001 includes two arc-extinguishing structures 3004. Two arc-extinguishing structures 3004 are provided side by side in the up-down direction at a predetermined interval. When the plurality of arc-extinguishing structures 3004 are included as described above, an arc is extended to bypass each of the plurality of arc-extinguishing structures 3004. Accordingly, the arc is extended longer than in a case in which one arc-extinguishing structure 3004 is included, and thus can be extinguished faster. Alternatively, contact device 3001 may include three arc-extinguishing structures 3004 or more.

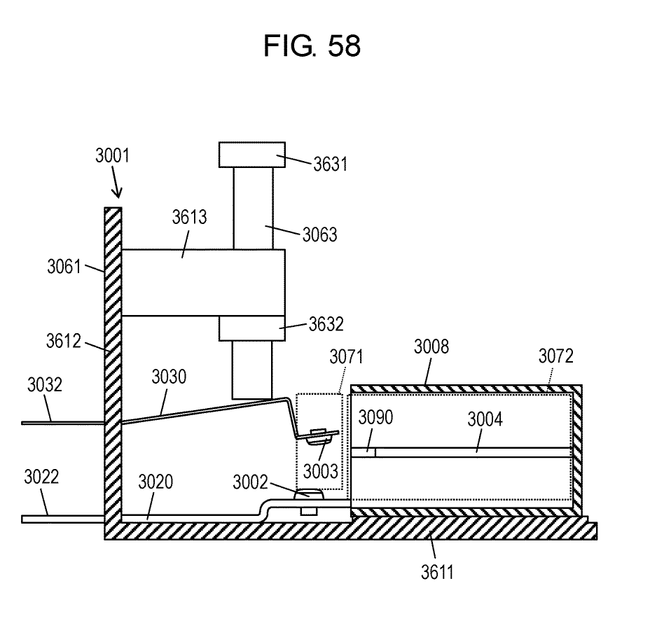

Contact device 3001 may include heat-resistant member 3090. As illustrated in FIG. 58, heat-resistant member 3090 is provided closer to movable region 3071 than a left end of arc-extinguishing structure 3004 in arc-extinguishing space 3072, in other words, on the left side of the left end of arc-extinguishing structure 3004. Heat-resistant member 3090 has a heat resistance higher than that of arc-extinguishing structure 3004, and is made of, for example metal, ceramic or resin. Heat-resistant member 3090 prevents an arc from contacting arc-extinguishing structure 3004, thereby suppressing wasting of arc-extinguishing structure 3004 to achieve a longer operating life. With heat-resistant member 3090 made of metal, a current flows through heat-resistant member 3090 to generate Joule heat when an arc contacts heat-resistant member 3090. However, this Joule heat is lower than heat of the arc, and thus wasting of arc-extinguishing structure 3004 can be reduced as compared to a case in which the arc contacts arc-extinguishing structure 3004. Arc-extinguishing structure 3004 and heat-resistant member 3090 may be provided integrally or separately.

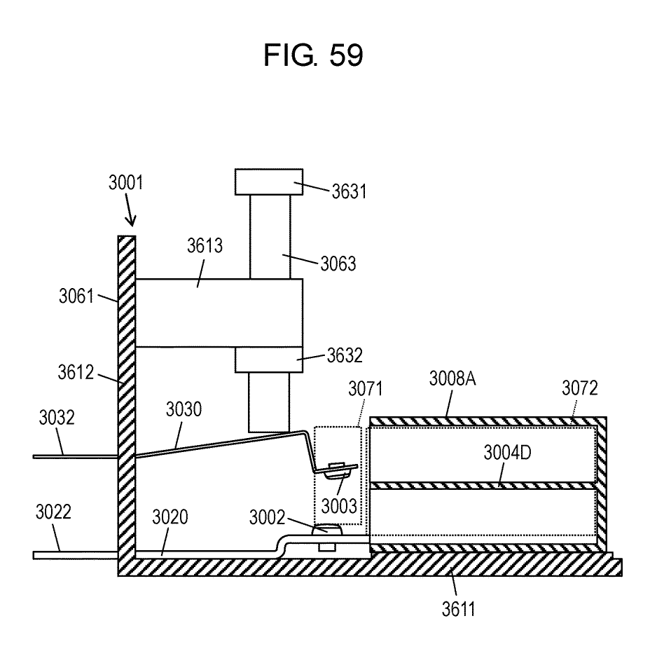

Arc-extinguishing structure 3004 and arc-extinguishing frame 3008 may be integrally provided. As illustrated in FIG. 59, arc-extinguishing structure 3004D and arc-extinguishing frame 3008A are integrally formed. This eliminates a need to perform an operation to attach arc-extinguishing structure 3004D to arc-extinguishing frame 3008A, thereby facilitating assembly of contact device 3001.

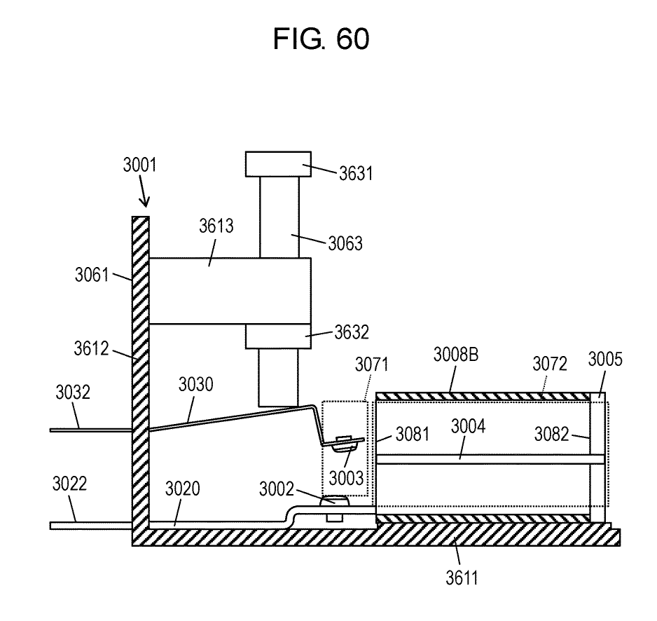

Arc-extinguishing frame 3008 may also include opening (hole) 3082 on a right surface. As illustrated in FIG. 60, arc-extinguishing frame 3008B includes opening 3081 on a left surface and also opening 3082 on a right surface. Since an arc has a high temperature, air inside arc-extinguishing frame 3008B is heated to expand by the arc. Since arc-extinguishing frame 3008B also includes opening 3082 on the right surface, however, the air expanded inside arc-extinguishing frame 3008B is ejected through opening 3082, suppressing an increase in air pressure inside arc-extinguishing frame 3008B. Accordingly, the extension of the arc can be prevented from being encumbered by the increase in air pressure inside arc-extinguishing frame 3008B. This facilitates the extension of the arc to extinguish the arc faster. Opening 3082 is formed on the right surface, which is most separated from fixed contact 3002 and movable contact 3003 among surfaces included in arc-extinguishing frame 3008B. This suppresses adhesion of, for example, metal included in the gas generated by the arc onto fixed contact 3002, movable contact 3003, and the like. A position of the opening (hole) provided to arc-extinguishing frame 3008 is not limited to the right surface, but the hole may be formed, for example, on the upper surface, the front surface, or the like of arc-extinguishing frame 3008. Arc-extinguishing frame 3008 may include a plurality of holes.

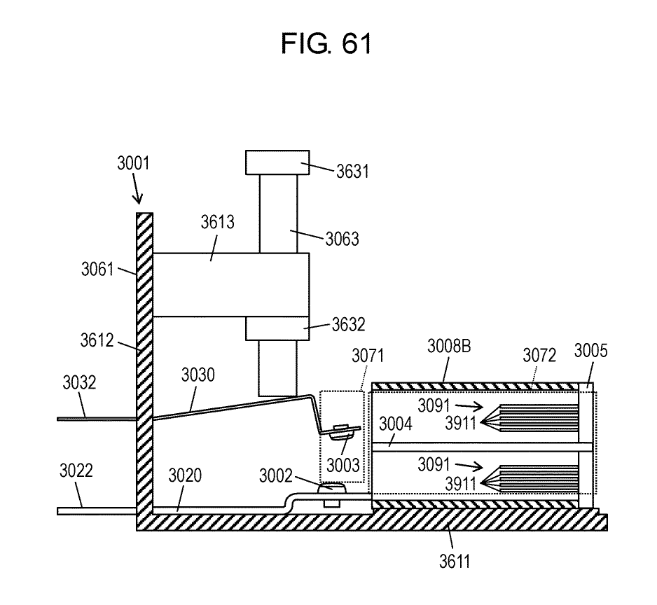

In addition, as illustrated in FIG. 61, contact device 3001 may include grid 3091. Grid 3091 includes a plurality of metal plates 3911 whose thickness directions are in the up-down direction, and the plurality of metal plates 3911 are provided side by side in the up-down direction at a predetermined gap. Grid 3091 is provided on the right side of an end part (left end) of arc-extinguishing structure 3004 closer to movable region 3071 in arc-extinguishing space 3072 inside arc-extinguishing frame 3008B. In the present exemplary embodiment, a right end of grid 3091 and a right end of arc-extinguishing frame 3008B are disposed to coincide with each other in the left-right direction. Contact device 3001 according to the present exemplary embodiment includes two grids 3091, one of grids 3091 being disposed on the upside of arc-extinguishing structure 3004, the other grid 3091 being disposed on the downside of arc-extinguishing structure 3004. When an arc extended into arc-extinguishing frame 3008B contacts grid 3091, an arc voltage rises, thereby extinguishing the arc faster.

The above-described exemplary embodiments are examples of the present invention. Thus, the present invention is not limited to the above-described exemplary embodiments, and various kinds of modifications other than these exemplary embodiments are possible through, for example, designing without departing from the technical idea of the present invention.

### REFERENCE MARKS IN THE DRAWINGS

1001: contact device
1002, 1002a, 1002b: fixed contact
1003, 1003a, 1003b: movable contact
1004, 1004a, 1004b: contact unit
1005, 1005A, 1005B, 1005C, 1005D, 1005E, 1005F: arc-extinguishing frame
1006, 1006A, 1006B, 1006C: magnet
1007: case
1010: electromagnetic device
1011: electromagnetic relay
1020, 1020a, 1020b: fixed contact plate
1021, 1021a, 1021b: contact holding part
1022, 1022a, 1022b: terminal part
1023: curved part
1030, 1030A, 1030a, 1030b: movable contact plate
1031: contact holding part
1032, 1032a, 1032b: terminal part
1033: curved part
1050, 1050A, 1050C, 1050E, 1050F: circulating flow path
1051, 1051a, 1051b: hole
1052, 1052A, 1052B, 1052C, 1052E, 1052F: internal wall
1053a, 1053b, 1054a, 1054b: hole
1061: yoke
1071: body
1072: cover
1073, 1073a, 1073b: movable shaft
1074, 1074A, 1074B: conducting member
1301, 1302, 1303: part
1501 sidewall
1521, 1521C, 1521E: hole
1711: bottom plate
1712: side plate
1713, 1713a, 1713b: holding part
1714, 1721: hole
1731, 1731A, 1731B, 1732: flange part
2001: contact device
2002, 2002a, 2002b: fixed contact
2003, 2003a, 2003b: movable contact
2004, 2004a, 2004b: contact unit
2005, 2005A, 2005B, 2005C, 2005D, 2005E, 2005F, 2005G, 2005H, 2005J, 2005K, 2005L: arc-extinguishing frame
2006, 2006A, 2006B, 2006C, 2006D, 2061, 2061A, 2062, 2062B: magnet
2007: case
2010: electromagnetic device
2011: electromagnetic relay
2020, 2020a, 2020b: fixed contact plate
2021: contact holding part
2022, 2022a, 2022b: terminal part
2023: curved part
2030, 2030a, 2030b: movable contact plate
2031: contact holding part
2032, 2032a, 2032b: terminal part
2033: curved part
2050, 2050A, 2050B: flow path
2051, 2051a, 2051b, 2058: hole
2052, 2052A, 2052B, 2052C, 2052D, 2054, 2054A, 2054B, 2056: ventilation hole
2053: air intake hole
2055: opening
2057: air intake and ejecting hole
2059: tilted part
2071: body
2072: cover
2073, 2073a, 2073b: movable shaft
2074, 2074A, 2074B: conducting member
2501: sidewall
2711: bottom plate
2712: side plate
2713: holding part
2714, 2721: hole
2731, 2731A, 2732: flange part
3001: contact device
3002: fixed contact
3003: movable contact
3004, 3004A, 3004B, 3004C, 3004D: arc-extinguishing structure
3005: magnet
3006: case
3008, 3008A, 3008B: arc-extinguishing frame
3009: contact unit
3010: electromagnetic device
3011: electromagnetic relay
3020: fixed contact plate
3021: contact holding part
3022, 3032: terminal part
3023, 3033: curved part
3030: movable contact plate
3031: contact holding part
3041, 3042: layer
3043: hole
3061: body
3062: cover
3063: movable shaft
3071: movable region
3072, 3072A, 3072B: arc-extinguishing space
3073: arc
3081, 3082: opening
3090: heat-resistant member
3091: grid
3611: bottom plate
3612: side plate
3613: holding part
3614, 3621: hole
3631, 3631A, 3632: flange part
3911: metal plate
L1, L2: width
Y1, Y2, Y3, Y4, Y5: arrow

1. A contact device comprising:
a first contact unit including a fixed contact and a movable contact configured to move between a closed position at which the movable contact is in contact with the fixed contact and an open position at which the movable contact is separate from the fixed contact;
a magnet configured to generate a magnetic field; and
an arc-extinguishing body,
wherein the arc-extinguishing body forms an arc-extinguishing space in a direction of action provided that the direction of action is a direction intersecting with a direction of the magnetic field applied to the first contact unit and with a direction in which the movable contact moves.

2. The contact device according to claim 1, wherein
the arc-extinguishing body includes an arc-extinguishing frame, and
the arc-extinguishing frame forms a flow path including a space in which the first contact unit is disposed, and at least part of the arc-extinguishing frame forms circulating flow path that is a ring-shaped and is along the direction of action.

3. The contact device according to claim 2, wherein
the circulating flow path includes a first space and a second space,
the first contact unit is disposed in the first space, and
a sectional area of the second space is smaller than a sectional area of the first space in a direction along the direction of action.

4. The contact device according to claim 1, wherein
the arc-extinguishing body includes an arc-extinguishing frame,
the arc-extinguishing frame forms a flow path communicating with at least one side with respect to a space including the first contact unit in the direction of action, and
the arc-extinguishing frame includes a first ventilation hole in a surface on at least one side of the first contact unit among surfaces facing the first contact unit in the direction of action.

5. The contact device according to claim 4, wherein the arc-extinguishing frame is provided around the first contact unit.

6. The contact device according to claim 5, wherein the arc-extinguishing frame includes an air intake hole in a surface opposite to the first ventilation hole with respect to the first contact unit in the direction of action.

7. The contact device according to claim 5, further comprising a second ventilation hole,
wherein the first ventilation hole and the second ventilation hole are provided in surfaces of the arc-extinguishing frame on both sides of the first contact unit in the direction of action.

8. The contact device according to claim 2, further comprising a second contact unit.

9. The contact device according to claim 8, wherein a direction of a force acting on a current flowing between the fixed contact and the movable contact due to the applied magnetic field is identical to each other between the first contact unit and the second contact unit.

10. The contact device according to claim 2, wherein the magnet is provided at a position surrounded by the circulating flow path.

11. The contact device according to claim 2, further comprising a second contact unit,
wherein the magnet is provided between the first contact unit and the second contact unit.

12. The contact device according to claim 11, further comprising:
a fixed contact plate that is long in one direction and includes the fixed contact, and
a movable contact plate that is long in one direction and includes the movable contact,
wherein
the magnet is formed in a plate long in one direction, and
longitudinal directions of the fixed contact plate, the movable contact plate, and the magnet are identical to each other.

13. The contact device according to claim 1, wherein the arc-extinguishing space is asymmetric with respect to the first contact unit.

14. The contact device according to claim 1, wherein
the arc-extinguishing body includes a first arc-extinguishing structure,
the movable contact moves in a movable region between the closed position at which the movable contact is in contact with the fixed contact and the open position at which the movable contact is separate from the fixed contact,
the first arc-extinguishing structure includes an insulator having an electric insulation property, and
the first arc-extinguishing structure is provided on at least one side of the movable region in the direction of action.

15. The contact device according to claim 14, further comprising an arc-extinguishing frame that includes an opening in a surface facing the movable region and is disposed around a space on the one side of the movable region in the direction of action, wherein the first arc-extinguishing structure is provided inside the arc-extinguishing frame.

16. The contact device according to claim 15, wherein the first arc-extinguishing structure and the arc-extinguishing frame are integrally formed.

17. The contact device according to claim 15, wherein the arc-extinguishing frame includes a hole.

18. The contact device according to claim 14, wherein the first arc-extinguishing structure is a plate.

19. The contact device according to claim 14, wherein the first arc-extinguishing structure is shaped in a rod whose axial direction is in a direction of the magnetic field in a space on the one side of the movable region in the direction of action.

20. The contact device according to claim 14, further comprising a second arc-extinguishing structure.

21. The contact device according to claim 14, wherein the first arc-extinguishing structure includes the insulator only.

22. The contact device according to claim 14, wherein the first arc-extinguishing structure includes a laminated body in which a plurality of layers made of materials different from each other are laminated.

23. The contact device according to claim 14, further comprising a heat-resistant member that is provided in an end part of the first arc-extinguishing structure closer to the movable region and has a heat resistance higher than a heat resistance of the first arc-extinguishing structure.

24. The contact device according to claim 14, further comprising a grid including a plurality of metal plates disposed at intervals, wherein the grid is provided on the one side of an end part of the arc-extinguishing structure closer to the movable region, on the one side of the movable region in the direction of action.

25. The contact device according to claim 4, further comprising a second contact unit.

26. The contact device according to claim 25, wherein a direction of a force acting on a current flowing between the fixed contact and the movable contact due to the applied magnetic field is identical to each other between the first contact unit and the second contact unit.
